(19) United States
(12) Patent Application Publication
(10) Pub. No.: US 2024/0393425 A1
(43) Pub. Date: Nov. 28, 2024

(54) COORDINATED DETECTION OF SPOOFING ATTACKS IN MULTI-RADAR COORDINATED INTERFERENCE OPERATION

(71) Applicant: QUALCOMM Incorporated, San Diego, CA (US)

(72) Inventors: Stelios STEFANATOS, San Diego, CA (US); Anantharaman BALASUBRAMANIAN, San Diego, CA (US); Kapil GULATI, Belle Mead, NJ (US)

(21) Appl. No.: 18/698,729

(22) PCT Filed: Nov. 18, 2022
(86) PCT No.: PCT/US2022/080180

§ 371 Date: Apr. 4, 2024

(30) Foreign Application Priority Data
Dec. 17, 2021 (GR) 20210100892

(51) Int. Cl. G01S 7/02; G01S 13/931

(52) U.S. Cl. CPC G01S 7/023; G01S 7/021; G01S 13/931; G01S 2013/9316

(57) ABSTRACT

Methods, systems, and devices for wireless communications are described. Aspects of the disclosure provide techniques for wireless devices utilizing wireless communications systems to perform radar operations to leverage challenges within radar signaling to detect one or more adverse parties attempting to spoof one or more radar signals. For example, a base station may transmit, to one or more vehicles, a message including an indication of a challenge type, when the challenge is to be applied, or both. Based on the challenge, one or more vehicles may detect that a device associated with the adverse party is not following the challenge as dictated in the message. Based on the detection, the one or more vehicles may report, to the base station, the detection of an adverse party attempting to spoof radars within the wireless communications system.

### CROSS REFERENCE

The present Application is a 371 national stage filing of International PCT Application No. PCT/US2022/080180 by STEFANATOS et al. entitled “COORDINATED DETECTION OF SPOOFING ATTACKS IN MULTI-RADAR COORDINATED INTERFERENCE OPERATION,” filed Nov. 18, 2022; and claims priority to Greece patent application No. 20210100892 by STEFANATOS et al., entitled “COORDINATED DETECTION OF SPOOFING ATTACKS IN MULTI-RADAR COORDINATED INTERFERENCE OPERATION,” filed Dec. 17, 2021, each of which is assigned to the assignee hereof, and each of which is expressly incorporated by reference in its entirety herein.

### FIELD OF TECHNOLOGY

The following relates to wireless communications, including coordinated detection of spoofing attacks in multi-radar coordinated interference operation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some radar systems may support techniques for devices within the radar systems to detect and categorize one or more physical targets. For example, a radar system may support radar operations at one or more wireless devices. In some cases, such as in high density urban environments, there may exist multiple wireless devices (e.g., vehicles) utilizing radar for detection and categorization of surrounding targets. Due to the density of such environments, however, many vehicles within the dense environment may transmit radar signals simultaneously, which may result in multi-radar coexistence leading to one or more adverse effects, such as an increased noise floor, detection of ghost targets, or both.

### SUMMARY

The described techniques relate to improved methods, systems, devices, and apparatuses that support coordinated detection of spoofing attacks in multi-radar coordinated interference operation. Generally, the described techniques provide for vehicles utilizing wireless communications systems to perform radar operations (e.g., such as in cellular vehicle-to-everything (C-V2X) systems) and to support coordinated challenges for detecting one or more adverse parties attempting to spoof (i.e., attempting to act as a legitimate wireless device in the radar system) one or more devices in the radar system. For example, a base station may transmit, to one or more vehicles, a message including an indication of a challenge type, when the challenge is to be applied, or both. As such, in cases where an adverse party is attempting to spoof one or more radar signals, the adverse party may not be aware of the challenge, and thus continue radar transmissions during the challenge. By continuing radar transmissions during the challenge period, one or more other devices (e.g., legitimate radar devices in the system, such as vehicles) may detect that the adverse party is not following the challenge as indicated in the message by the base station. That is, the adverse party may fail the challenge. Based on the detection of the adverse party failing the challenge, the one or more vehicles may report, to the base station or to one another, the detection of an adverse party attempting to spoof radars within the wireless communications system.

A method for wireless communications at a user equipment (UE) is described. The method may include transmitting, by the UE operating in a first detection mode, a first set of radar signals in accordance with a first set of operating parameters for radar signaling, switching from the first detection mode to a second detection mode associated with a second set of coordinated operating parameters for radar signaling, the second set of coordinated operating parameters associated with the UE and one or more wireless devices in coordination with the UE, and performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

An apparatus for wireless communications at a UE is described. The apparatus may include a processor, memory coupled with the processor, and one or more instructions stored in the memory. The instructions may be executable by the processor to cause the apparatus to transmit, by the UE operating in a first detection mode, a first set of radar signals in accordance with a first set of operating parameters for radar signaling, switch from the first detection mode to a second detection mode associated with a second set of coordinated operating parameters for radar signaling, the second set of coordinated operating parameters associated with the UE and one or more wireless devices in coordination with the UE, and perform, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

Another apparatus for wireless communications at a UE is described. The apparatus may include means for transmitting, by the UE operating in a first detection mode, a first set of radar signals in accordance with a first set of operating parameters for radar signaling, means for switching from the first detection mode to a second detection mode associated with a second set of coordinated operating parameters for radar signaling, the second set of coordinated operating parameters associated with the UE and one or more wireless devices in coordination with the UE, and means for performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

A non-transitory computer-readable medium storing code for wireless communications at a UE is described. The code may include instructions executable by a processor to transmit, by the UE operating in a first detection mode, a first set of radar signals in accordance with a first set of operating parameters for radar signaling, switch from the first detection mode to a second detection mode associated with a second set of coordinated operating parameters for radar signaling, the second set of coordinated operating parameters associated with the UE and one or more wireless devices in coordination with the UE, and perform, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

In some examples of the method, apparatuses, and non-transitory computer-readable medium described herein, performing the security procedure may include operations, features, means, or instructions for refraining from transmitting radar signals during the challenge interval and monitoring for one or more interfering radar signals from the interfering wireless device during the challenge interval.

In some examples of the method, apparatuses, and non-transitory computer-readable medium described herein, performing the security procedure may include operations, features, means, or instructions for transmitting, during the challenge interval, a second set of radar signals in accordance with the second set of coordinated operating parameters.

Some examples of the method, apparatuses, and non-transitory computer-readable medium described herein may further include operations, features, means, or instructions for receiving, from a wireless device, an indication of the security procedure for detecting the interfering wireless device, the indication of the security procedure indicating a type of challenge for the security procedure, timing information for the security procedure, or any combination thereof, where the timing information includes a start time associated with the security procedure, a number of frames for the security procedure, an end time of the security procedure, one or more challenge intervals for the security procedure, a duration of the challenge interval, or any combination thereof.

In some examples of the method, apparatuses, and non-transitory computer-readable medium described herein, receiving the indication of the security procedure may include operations, features, means, or instructions for receiving the indication of the security procedure via a groupcast message for a group of wireless devices including the UE and the one or more wireless devices or a unicast message for the UE.

In some examples of the method, apparatuses, and non-transitory computer-readable medium described herein, receiving the indication of the security procedure may include operations, features, means, or instructions for receiving an encrypted message including the indication of the security procedure and decrypting the encrypted message based on an encryption key associated with the UE and the one or more wireless devices in coordination with the UE.

In some examples of the method, apparatuses, and non-transitory computer-readable medium described herein, performing the security procedure may include operations, features, means, or instructions for performing the security procedure at the start time indicated by the timing information and during the number of frames indicated by the timing information.

In some examples of the method, apparatuses, and non-transitory computer-readable medium described herein, the security procedure includes a default security procedure or a fallback security procedure.

In some examples of the method, apparatuses, and non-transitory computer-readable medium described herein, performing the security procedure may include operations, features, means, or instructions for performing the security procedure according to a periodicity for the security procedure, where the second set of coordinated operating parameters includes a waveform different from the first set of operating parameters.

In some examples of the method, apparatuses, and non-transitory computer-readable medium described herein, the timing information includes random timing information indicating an aperiodicity associated with the security procedure.

In some examples of the method, apparatuses, and non-transitory computer-readable medium described herein, performing the security procedure may include operations, features, means, or instructions for monitoring a set of radar resources for one or more radar signals in accordance with the sensing procedure and transmitting a report indicating one or more measurement results of the sensing procedure based on the monitoring.

In some examples of the method, apparatuses, and non-transitory computer-readable medium described herein, the one or more measurement results includes a hard indicator corresponding to whether the interfering wireless device may be present or a soft indicator corresponding to whether the interfering wireless device may be present, a field of view associated with the UE, a position of the UE, a direction associated with a radar component of the UE, or any combination thereof.

In some examples of the method, apparatuses, and non-transitory computer-readable medium described herein, the hard indicator includes a Boolean value associated with whether the interfering wireless device may be present based on the monitoring and the soft indicator includes a probability associated with whether the interfering wireless device may be present, a signal strength associated with the one or more radar signals based on the monitoring, or any combination thereof.

In some examples of the method, apparatuses, and non-transitory computer-readable medium described herein, the report may be transmitted to a base station via an uplink message, a sidelink message, or both, to at least one wireless device of the one or more wireless devices via a sidelink message, to the one or more wireless devices via a groupcast message or a broadcast message, or any combination thereof.

Some examples of the method, apparatuses, and non-transitory computer-readable medium described herein may further include operations, features, means, or instructions for transmitting a trigger message to at least one wireless device of the one or more wireless devices, where the trigger message instructs the at least one wireless device to perform a corresponding security procedure during the challenge interval.

In some examples of the method, apparatuses, and non-transitory computer-readable medium described herein, transmitting the trigger message may include operations, features, means, or instructions for transmitting an encrypted message including the trigger message via a broadcast message to the one or more wireless devices, a groupcast message to a group of wireless devices including the at least one wireless device, a unicast message to the at least one wireless device, or any combination thereof.

In some examples of the method, apparatuses, and non-transitory computer-readable medium described herein, the corresponding security procedure may include operations, features, means, or instructions for a request to apply a same security procedure as the UE during the challenge interval, to remain silent during the challenge interval, to perform a sensing procedure for the security procedure during the challenge interval, to report sensing results associated with the sensing procedure, or any combination thereof.

In some examples of the method, apparatuses, and non-transitory computer-readable medium described herein, the request includes a request type, the request type including on of an optional request or a mandatory request.

In some examples of the method, apparatuses, and non-transitory computer-readable medium described herein, the corresponding security procedure includes the request to report sensing results associated with the sensing procedure and the method, apparatuses, and non-transitory computer-readable medium may include further operations, features, means, or instructions for receiving, from the at least one wireless device, a sensing report, a hard indicator, a soft indicator, or some combination thereof, indicating one or more sensing results of the sensing procedure at the at least one wireless device and transmitting a combined sensing report to a wireless device, the combined sensing report, the hard indicator, the soft indicator, or some combination thereof, including the one or more sensing results and at least one additional sensing result.

A method for wireless communications at a wireless device is described. The method may include selecting a type of challenge, timing information, or both for a security procedure for detecting an interfering wireless device within a radar system, transmitting, to a UE, an indication of the security procedure for detecting the interfering wireless device, the indication of the security procedure indicating the type of challenge for the security procedure, the timing information for the security procedure, or both, and monitoring a set of radar resources for one or more messages during a challenge interval associated with the security procedure based on the indication of the security procedure.

An apparatus for wireless communications at a wireless device is described. The apparatus may include a processor, memory coupled with the processor, and one or more instructions stored in the memory. The instructions may be executable by the processor to cause the apparatus to select a type of challenge, timing information, or both for a security procedure for detecting an interfering wireless device within a radar system, transmit, to a UE, an indication of the security procedure for detecting the interfering wireless device, the indication of the security procedure indicating the type of challenge for the security procedure, the timing information for the security procedure, or both, and monitor a set of radar resources for one or more messages during a challenge interval associated with the security procedure based on the indication of the security procedure.

Another apparatus for wireless communications at a wireless device is described. The apparatus may include means for selecting a type of challenge, timing information, or both for a security procedure for detecting an interfering wireless device within a radar system, means for transmitting, to a UE, an indication of the security procedure for detecting the interfering wireless device, the indication of the security procedure indicating the type of challenge for the security procedure, the timing information for the security procedure, or both, and means for monitoring a set of radar resources for one or more messages during a challenge interval associated with the security procedure based on the indication of the security procedure.

A non-transitory computer-readable medium storing code for wireless communications at a wireless device is described. The code may include instructions executable by a processor to select a type of challenge, timing information, or both for a security procedure for detecting an interfering wireless device within a radar system, transmit, to a UE, an indication of the security procedure for detecting the interfering wireless device, the indication of the security procedure indicating the type of challenge for the security procedure, the timing information for the security procedure, or both, and monitor a set of radar resources for one or more messages during a challenge interval associated with the security procedure based on the indication of the security procedure.

In some examples of the method, apparatuses, and non-transitory computer-readable medium described herein, transmitting the indication of the security procedure may include operations, features, means, or instructions for transmitting a groupcast message to a group of wireless devices including the UE and one or more wireless devices in coordination with the UE, where the groupcast message includes the indication of the security procedure.

In some examples of the method, apparatuses, and non-transitory computer-readable medium described herein, transmitting the indication of the security procedure may include operations, features, means, or instructions for transmitting a unicast message for the UE, where the unicast message includes the indication of the security procedure.

In some examples of the method, apparatuses, and non-transitory computer-readable medium described herein, transmitting the indication of the security procedure may include operations, features, means, or instructions for transmitting an encrypted message including the indication of the security procedure, where the encrypted message may be encrypted based on an encryption key associated with the UE and one or more wireless devices in coordination with the UE.

In some examples of the method, apparatuses, and non-transitory computer-readable medium described herein, transmitting the indication of the security procedure may include operations, features, means, or instructions for transmitting a sensing procedure indication to the UE, where the sensing procedure indication includes a request to report sensing results for a sensing procedure associated with the security procedure, an indication of whether the UE may be to detect the interfering wireless device, or a combination thereof.

Some examples of the method, apparatuses, and non-transitory computer-readable medium described herein may further include operations, features, means, or instructions for monitoring for one or more sensing reports based on the sensing procedure indication.

Some examples of the method, apparatuses, and non-transitory computer-readable medium described herein may further include operations, features, means, or instructions for selecting the UE from a set of wireless devices of the radar system based on a position of the UE, a radar direction of the UE, a transmit power associated with the UE, or any combination thereof.

In some examples of the method, apparatuses, and non-transitory computer-readable medium described herein, selecting the type of challenge, the timing information, or both for the security procedure may include operations, features, means, or instructions for randomly selecting the type of challenge, the timing information, or both for the security procedure.

In some examples of the method, apparatuses, and non-transitory computer-readable medium described herein, the timing information includes a start time associated with the security procedure, a number of frames for the security procedure, an end time of the security procedure, one or more challenge intervals for the security procedure, a duration of the challenge interval, a periodicity for the security procedure, or any combination thereof.

In some examples of the method, apparatuses, and non-transitory computer-readable medium described herein, the type of challenge instructs the UE to remain silent for a duration of the challenge interval.

In some examples of the method, apparatuses, and non-transitory computer-readable medium described herein, the type of challenge instructs the UE to transmit radar signals according to a set of operating parameters for the security procedure for a duration of the challenge interval.

### BRIEF DESCRIPTION OF THE DRAWINGS

FIG. 1 illustrates an example of a wireless communications system that supports coordinated detection of spoofing attacks in multi-radar coordinated interference operation in accordance with aspects of the present disclosure.

FIG. 2 illustrates an example of a wireless communications system that supports coordinated detection of spoofing attacks in multi-radar coordinated interference operation in accordance with aspects of the present disclosure.

FIG. 3 illustrates an example of a wireless communications system that supports coordinated detection of spoofing attacks in multi-radar coordinated interference operation in accordance with aspects of the present disclosure.

FIG. 4 illustrates an example of a process flow that supports coordinated detection of spoofing attacks in multi-radar coordinated interference operation in accordance with aspects of the present disclosure.

FIGS. 5 and 6 show block diagrams of devices that support coordinated detection of spoofing attacks in multi-radar coordinated interference operation in accordance with aspects of the present disclosure.

FIG. 7 shows a block diagram of a communications manager that supports coordinated detection of spoofing attacks in multi-radar coordinated interference operation in accordance with aspects of the present disclosure.

FIG. 8 shows a diagram of a system including a device that supports coordinated detection of spoofing attacks in multi-radar coordinated interference operation in accordance with aspects of the present disclosure.

FIGS. 9 and 10 show block diagrams of devices that support coordinated detection of spoofing attacks in multi-radar coordinated interference operation in accordance with aspects of the present disclosure.

FIG. 11 shows a block diagram of a communications manager that supports coordinated detection of spoofing attacks in multi-radar coordinated interference operation in accordance with aspects of the present disclosure.

FIG. 12 shows a diagram of a system including a device that supports coordinated detection of spoofing attacks in multi-radar coordinated interference operation in accordance with aspects of the present disclosure.

FIGS. 13 through 15 show flowcharts illustrating methods that support coordinated detection of spoofing attacks in multi-radar coordinated interference operation in accordance with aspects of the present disclosure.

### DETAILED DESCRIPTION

Aspects of the present disclosure enable vehicles in wireless communications systems to perform radar operations (e.g., such as in cellular vehicle-to-everything (C-V2X) systems) that support the use of challenges for detecting one or more adverse parties attempting to spoof one or more radar signals (e.g., an illegitimate radar device may generate radar signals that are similar to those utilized by legitimate devices in the system). For example, a malicious device may learn a waveform associated with a first radar (e.g., by listening and utilizing one or more techniques to learn and simulate, mimic, or imitate the waveform, such as via a machine learning procedure) and proceed to transmit the learned waveform with an appropriate delay such that the first radar detects a ghost target (e.g., target spoofing). Such spoofing may trigger an action at a vehicle such as emergency braking, which may be an inappropriate action for the vehicle to perform at that time. To mitigate such spoofing, a base station may transmit, to one or more vehicles, a message including an indication of a challenge type, when the challenge is to be applied, or both. For example, the message may instruct the one or more vehicles under the control of the base station to cease radar transmissions (e.g., which may be the challenge type) during one or more periods of time (e.g., when the challenge is to be applied). Based on the message, the one or more vehicles may cease radar transmissions during the one or more periods of time in a coordinated fashion. As such, in cases where an adverse party is attempting to spoof one or more radar signals, the adverse party may not be aware of the challenge, and thus may continue radar transmissions during the one or more periods of time. By continuing radar transmissions during the challenge period, legitimate radar devices (e.g., vehicles in the radar system) may detect the existence of the adverse party as the adverse party is not following the challenge as indicated in the message from the base station. Based on the detection, the one or more vehicles may report, to the base station or to one another, the detection of an adverse party attempting to spoof radars within the wireless communications system.

Aspects of the disclosure are initially described in the context of wireless communications systems. Aspects of the disclosure are further illustrated by and described with reference to a process flow. Aspects of the disclosure are further illustrated by and described with reference to apparatus diagrams, system diagrams, and flowcharts that relate to coordinated detection of spoofing attacks in multi-radar coordinated interference operation.

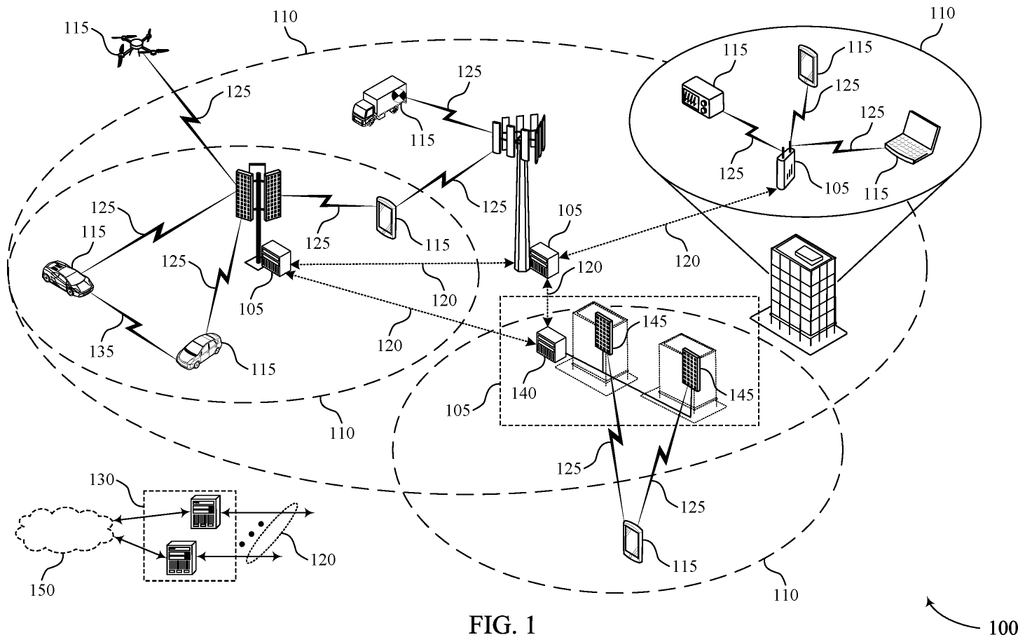

FIG. 1 illustrates an example of a wireless communications system 100 that supports coordinated detection of spoofing attacks in multi-radar coordinated interference operation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

Radar and associated operations may be supported by a UE 115, which may be a component of, a user of, or otherwise associated with a vehicle. Radar may be useful for environmental sensing, particularly when coupled with other sensors such as cameras and light detection and ranging (LIDAR). Additionally, radar components may be low cost and may operate reliably under low visibility conditions. Automotive radars may be categorized as long-range, medium-range, or short-range radars, which may assist a corresponding vehicle with operations such as autonomous driving, lane changing, emergency braking, and the like. Such applications may be associated with high data rates and low latency communications and processing. Accordingly, automotive radars may operate in the 77 giga-hertz (GHz) band without any restrictions in term of channel access. With an ever-increasing number of radar-equipped vehicles, radar-to-radar interference may pose unique challenges. For example, without providing techniques to handle radar-to-radar interference, interference may be experienced at one or more vehicles, which may lead to inaccurate radar detections. For example, a victim vehicle (e.g., a victim of interference) may experience masking of legitimate targets due to increased broadband level noise, false identification of non-existent (e.g., ghost) targets, or both.

To reduce detrimental effects and results associated with radar-to-radar interference, coordinated interference may be supported which specifies that all radars in a geographic area operate using the same waveform (e.g., a frequency modulated continuous waveform (FMCW), multi-radar coexistence), which may reduce or eliminate the broadband noise level experienced due to interference and the corresponding masking of legitimate targets, by one or more victim vehicles. For example, coordinated interference may be instantiated by the wireless communications system 100, where a base station 105 may transmit a coordination message to a set of radars in communication with the base station 105. However, a victim vehicle may not be able to differentiate between a signal associated with the victim vehicle (e.g., a reflected radar signal initially transmitted by the victim vehicle) and signals originating from other vehicles, which may be interpreted as ghost targets. Random offsets may be applied by radars associated with each vehicle within the geographic area in each transmission period, which may result in ghost target detections appearing to hop erratically among successive periods, enabling a victim vehicle to detect and discard the ghost targets as they do not exhibit real-world behavior (e.g., does not agree with a real-world mobility model).

Accordingly, coordinated interference may mitigate adverse effects associated with multi-radar coexistence without sophisticated signal processing, varying waveforms, or channel access mechanisms and associated signaling that may congest a communication channel. As such, coordinated interference may result in radars effectively operating as if the radar resides in interference-free conditions. However, while coordinated interference provides techniques for minimizing and eliminating interference effects in multi-radar coexistence scenarios, coordinated interference may also be vulnerable to attack (e.g., by a malicious device attempt to mimic a legitimate radar device within the system).

For example, a malicious device may learn an FMCW waveform associated with a first radar (e.g., by listening and utilizing one or more techniques to learn and simulate the FMCW waveform, such as via a machine learning procedure) and proceed to transmit the learned FMCW waveform with an appropriate delay such that the first radar detects a ghost target (e.g., target spoofing). Such spoofing may trigger an action at the vehicle associated with the first feature such as emergency braking, which may be inappropriate. Further, under coordinated interference, all legitimate radars (e.g., radars associated with vehicles associated with or in communication with the base station 105) in a geographic area 130 may transmit the same waveform, which makes learning the waveform easier for a malicious device to learn (e.g., as there are many sources to learn and validate against). Accordingly, a malicious device listening to multiple vehicles under coordinated interference may learn the common FMCW waveform, impact more than one radar in the geographic area (e.g., since all legitimate vehicles are utilizing the same waveform), all while remaining difficult to detect as malicious or spoofed transmissions may appear legitimate under coordinated interference (e.g., none of the victim vehicles may detect the malicious device or recognize being victims of spoofing).

While random offsets may be useful in helping detecting and discarding spoofed ghost targets generated by malicious transmissions, the malicious device may be capable of learning the random offset pattern associated with a given radar and align with it. Additionally or alternatively, the malicious device may employ multiple radars, where the malicious device may apply different period offsets to increase chances that one of the periods align with a period of a legitimate radar. Additionally, the malicious device may operate undetected as coordinated interference operations treat all interferers as legitimate and is used primarily to reduce interference experienced by the device without explicitly detecting the source of the interference.

Accordingly, aspects of the present disclosure provide techniques for vehicles (e.g., UEs 115) within a wireless communications system 100 to detect one or more adverse parties (e.g., malicious devices) attempting to spoof one or more radar signals. For example, the base station 105 may transmit, to one or more vehicles, a message including an indication of a challenge type, when the challenge is to be applied, or both. As such, in cases where an adverse party is attempting to spoof one or more radar signals, the adverse party may not be aware of the challenge, and thus continue radar transmissions during the challenge. By continuing radar transmissions during the challenge period, one or more vehicles may detect that the adverse party is not following the challenge as indicated in the message from the base station 105. Based on the detection, the one or more vehicles may report, to the base station 105 or to other vehicles or UEs 115, the detection of an adverse party attempting to spoof radars within the wireless communications system 100.

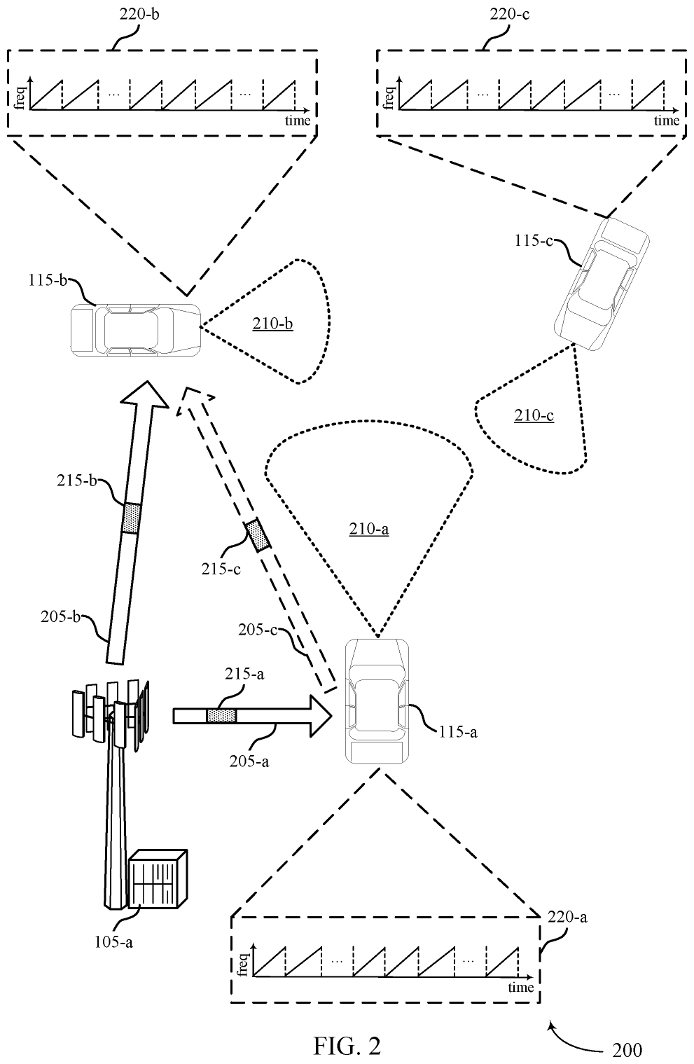

FIG. 2 illustrates an example of a wireless communications system 200 that supports coordinated detection of spoofing attacks in multi-radar coordinated interference operation in accordance with aspects of the present disclosure. The wireless communications system 200 may implement or be implemented by one or more aspects of the wireless communications system 100. For example, the wireless communications system 200 may include a UE 115-a, a UE 115-b, a UE 115-c, and a base station 105-a, which may be examples of the corresponding devices described herein. It should be noted that, while examples are discussed below, any number of devices and device types may be used to accomplish implementations described in the present disclosure.

In the wireless communications system 200, the UE 115-a and the UE 115-b may correspond to legitimate vehicles that support radar communications, and may be capable of communication with each other or the base station 105-a. The base station 105-a may transmit messages that indicate instructions, resources, or the like to the UEs 115-a and 115-b. For example, the base station 105-a may instruct the UEs 115-a and 115-b to perform Mode 2 sidelink communications (e.g., over a communication link 205-a and a communication link 205-b). That is, the base station 105-a may determine resource pools with which the UEs 115-a and 115-b may perform contention-based access for subsequent sidelink transmissions. Based on the contention-based access, the UEs 115-a and 115-b may exchange sidelink information (e.g., over a communication link 205-c). Additionally or alternatively, the UEs 115-a and 115-b may perform radar operations in support of one or more activities (e.g., according to a first set of operating parameters), such as autonomous driving. In such cases, each of the UEs 115-a and 115-b may perform radar transmissions to characterize and, in some cases, perform actions in response to the detection of objects by the UEs 115-a and 115-b. For example, the UE 115-a may transmit a radar signal 210-a to sense objects in an area near the UE 115-a while performing autonomous driving operations. Similarly, the UE 115-b may transmit a radar signal 210-b to sense objects in an area near the UE 115-b.

The UEs 115-a and 115-b may utilize separate waveforms for the radar signals 210-a and 210-b to mitigate interference between the UEs 115-a and 115-b. For example, the UE 115-a may utilize a first waveform for the radar signal 210-a such that the radar signal 210-a does not interfere with received radar signals at the UE 115-b. Similarly, the UE 115-b may utilize a second waveform for the radar signal 210-b such that the radar signal 210-b does not interfere with received radar signals at the UE 115-a. In some cases, however, the UEs 115-a and 115-b may utilize a common waveform for radar operations (e.g., such as when operating under coordinated interference). For example, when performing coordinated interference, the UE 115-a may utilize a waveform 220-a for radar operations, where the waveform 220-a may be realized by any number of waveform combinations for the radar signal 210-a (e.g., chirped radar transmissions). Additionally, the UE 115-b may utilize a waveform 220-b for the radar signal 210-b, where the waveform 220-a and 220-b are the same waveform (e.g., an FMCW waveform).

In some examples, a malicious device (e.g., the UE 115-c) may reside within the vicinity of the UEs 115-a and 115-b, where the UE 115-c may attempt to spoof one or more radar transmissions associated with the UE 115-a, the UE 115-b, or both. For example, the UE 115-c may listen for the radar signal 210-a, the radar signal 210-b, or both, and may learn the common waveform used by the UEs 115-a and 115-b. Accordingly, the UE 115-c may generate the common waveform (e.g., waveform 220-c) and transmit a radar signal 210-c using the common waveform. As the waveform 220-c corresponds to a common waveform, the UE 115-c may spoof one or more radar signals such that the UE 115-a, UE 115-b, or both detect a target corresponding to the spoofed one or more radar signals, which may be an erroneous target. Detecting erroneous targets at the UEs 115-a, 115-b, or both, may lead to one or more actions performed by the UE 115-a, UE 115-b, or both (e.g., evasive maneuvers). Actions performed based on a spoofed target may present dangers to users associated with the UE 115-a, the UE 115-b, as well as any UEs 115 or users surrounding the UEs 115-a and 115-b. Accordingly, preventing malicious actors from spoofing one or more UEs may increase safety of users within the wireless communications system 200.

Aspects of the present disclosure provide techniques for legitimate UEs (e.g., the UEs 115-a and 115-b) to perform radar operations in a coordinated fashion (e.g., coordinated interference) while additionally performing a security procedure by coordinating challenges to detect spoofing attacks according to a second set of coordinated operating parameters. The base station 105-a may determine the second set of coordinated operating parameters (e.g., a challenge type, timing information associated with the challenge type, or the like) prior to implementing the challenge (e.g., random-like challenge types, challenge times, or both, to prevent malicious actors from learning the challenge). For example, the base station 105-a may be preconfigured with a type of challenge. An example of a preconfigured type of challenge may correspond to all legitimate UEs refraining from transmitting radar signals during certain periods (e.g., during the challenge interval). In some examples, the preconfigured type of challenge may correspond to a default or fallback challenge.

In some examples, the base station 105-a may determine timing information associated with the preconfigured challenge to ensure the challenge includes random aspects to prevent malicious devices from learning the challenge. That is, the challenges present a second level of randomness (e.g., on top of the pseudo-random offset under coordinated interference), which may allow for attack detection (e.g., since the attacker will likely fail the challenge) while also providing robust security measures against malicious devices. In some cases, the timing information for the security procedure may include a start time associated with the security procedure, a number of frames (e.g., periods) for the security procedure, an end time for the security procedure, one or more challenge intervals for the security procedure, a duration of the challenge interval, or some combination thereof.

In other examples, the base station 105-a may be preconfigured with a timing associated with a challenge type, where the challenge type may be determined dynamically (e.g., pseudo-randomly). For example, the challenge may be preconfigured to be applied every 10 frames, where radar transmissions from legitimate devices may utilize a different waveform, as indicated by the base station, when the challenge is applied.

In other cases, both the challenge type and challenge timing may be determined on-the-fly and in a random-like manner to further improve security (e.g., so the malicious device may not determine either the challenge type or the challenge timing). Based on the determination, the base station 105-a may select a challenge (e.g., a type of challenge, when the challenge is to be applied) that legitimate devices may implement within the wireless communications system 200. The coordination of challenges may ensure that the challenges are issued in a manner that detection of a challenge failure can only mean that a radar associated with a malicious actor is transmitting (e.g., the radar signal 210-c).

To coordinate the security procedure (e.g., the challenges), one or more messages may be exchanged between the UE 115-a, the UE 115-b, the base station 105-a, or some combination thereof. For example, the base station 105-a may determine to initiate the security procedure. The determination to initiate the security procedure may be based on an indication associated with the wireless communications system 200, a configuration, a trigger, or some combination thereof. For example, the base station 105-a may periodically determine and indicate a challenge associated with the security procedure. In some examples, the period associated with the indication of the challenge may be known (e.g., preconfigured) or dynamically selected by the wireless communications system 200, the base station 105-a, or both. In other examples, the base station 105-c may determine and indicate the challenge based on a trigger, where the trigger instructs one or more legitimate wireless devices to initiate the security procedure. For example, one or both of the UEs 115-a and 115-b may experience abnormal detections and transmit an encrypted trigger (e.g., a challenge coordination request to detect a potential malicious attack) to one or more wireless devices (e.g., the base station 105-a or other UEs 115). Based on the encrypted trigger, the one or more wireless devices may decrypt the trigger using an encryption key and subsequently perform the security procedure associated with the trigger.

According to some aspects, the base station 105-a may determine and indicate the challenge based on a pseudo-random (e.g., non-periodic) manner. For example, the base station 105-a may transmit indications of the challenge in an aperiodic fashion to prevent malicious devices from learning a period with which the challenge indications are issued. Otherwise, the malicious devices may learn when challenge indications are issued and may jam communication channels over which the challenge indication is transmitted (e.g., communication link 205-a, 205-b) so that the legitimate devices in the wireless communications system 200 are not aware of the challenge indication and thus do not apply the challenge.

Upon determining in what manner to transmit the challenge indication, the base station 105-a may indicate the type of challenge and when the challenge is to be applied (e.g., challenge parameters) to one or more legitimate devices within the wireless communications system 200 (e.g., devices under the control of the base station 105-a, such as the UEs 115-a and 115-b). In some cases, the base station 105-a may indicate the challenge parameters via a single groupcast transmission. In other cases, the base station 105-a may indicate the challenge parameters via multiple unicast transmissions. For example, the base station 105-a may transmit an indication of the challenge parameters to the UE 115-a via a message 215-a over the communication link 205-a. Similarly, the base station 105-a may transmit an indication of the challenge parameters to the UE 115-b via a message 215-b over the communication link 205-b.

In some examples, however, the wireless communications system 200, the base station 105-a, or both, may determine to restrict which devices may apply the challenge to a subset of radars. For example, the base station 105-a may restrict challenge applications over an isolated subset of radars where there may be an indication (e.g., suspicion at one or more devices) of a malicious device attempting nefarious activities. In such cases, the base station 105-a may determine an isolated subset of radars by tracking information such as position, pointing direction, transmission power, and the like to determine the subset of radars potentially experiencing malicious spoofing. In some examples, the base station 105-a may indicate, during the challenge, whether the subset of radars is expected to sense or detect an attack. In some examples, the base station 105-a may only initiate the challenge and avoid overhead of fusing (e.g., combining) results from other radars. In such cases, the subset of radars may determine, amongst themselves, whether an attack is occurring. Restricting which devices may apply the challenge may correspond to an efficient approach as the signaling for implementing challenges is localized to where an incident may be occurring.

In any case, the challenge parameters that are transmitted from the base station 105-a to the UEs 115-a and 115-b via groupcast or unicast may be encrypted with a key that legitimate devices may decrypt (e.g., via an encryption key associated with the UEs 115-a and 115-b). For example, the UE 115-a may receive the message 215-a via downlink communications over the communication link 205-a and subsequently decrypt the message 215-a according to the encryption key to obtain the challenge parameters. Based on the challenge parameters, the UE 115-a may implement the challenge parameters. For example, the UE 115-a may determine, from the challenge parameters, the type of challenge to be applied and when the challenge is to be applied.

In some cases, however, the UEs 115-a and 115-b may coordinate a challenge without the assistance of the base station 105-c (e.g., under limited or no coverage conditions). For example, the UE 115-a may determine to initiate a challenge. In such cases, the UE 115-a may transmit a message 215-c to other UEs (e.g., the UE 115-b) over the communication link 205-c. In other cases, the UE 115-a may transmit the message 215-c to all legitimate radars in an area without discrimination (e.g., using an encrypted broadcast message). Additionally, radars that may be legitimately interfering with other radars (e.g., when operating under coordinated interference) may be aware of the interference via previous signaling indicating positions, pointing direction, and transmit power associated with the legitimately interfering radars. As such, based on the legitimately interfering radars, the UE 115-a may issue a groupcast or multiple unicast encrypted messages to transmit the message 215-c to other UEs.

In some cases, the message 215-c may be encrypted and include challenge parameters associated with the challenge. Additionally or alternatively, the message 215-c may include a request for other radars (e.g., at other devices within the wireless communications system 200) to apply the challenge at their respective radars, remain silent during intervals where the UE 115-a applies its own challenges (e.g., if the challenge type is not remaining silent), or both. In some examples, the message 215-c may also include a request for other radars to measure activity, sense activity, or both, during the challenge periods. The message 215-c may include a further request to report results associated with the measuring and sensing (e.g., to the base station 105-a, to the UE 115-a, or any combination of wireless devices within the wireless communications system 200). In some cases, the request to report the results may be mandatory or optional, and may be explicitly indicated within the message 215-c or preconfigured.

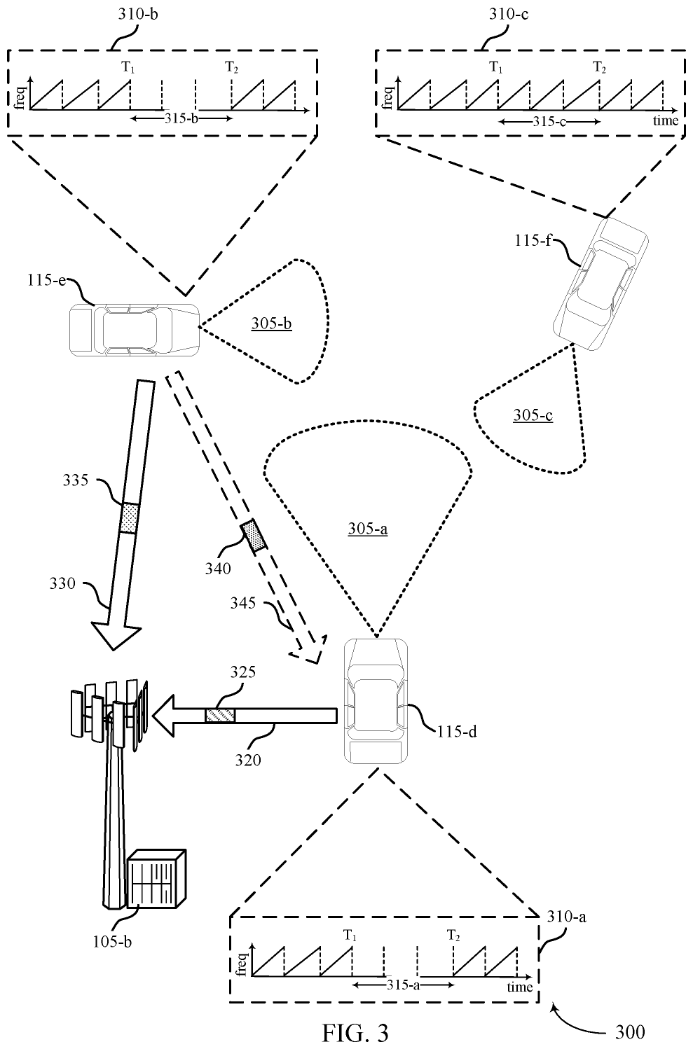

FIG. 3 illustrates an example of a wireless communications system 300 that supports coordinated detection of spoofing attacks in multi-radar coordinated interference operation in accordance with aspects of the present disclosure. The wireless communications system 300 may include one or more aspects of the wireless communications system 100 and the wireless communications system 200. For example, the wireless communications system 300 may include a UE 115-d, a UE 115-e, a UE 115-f, and a base station 105-b, which may be examples of the corresponding devices described herein. It should be noted that, while examples are discussed below, any number of devices and device types may be used to accomplish implementations described in the present disclosure.

The wireless communications system 300 illustrates an implementation of a challenge according to an indicated set of challenge parameters (e.g., as indicted by the base station 105-a, as determined by one of the UEs 115-d and 115-e, or a combination thereof) with devices operating under coordinated interference (e.g., utilizing FMCW waveforms). For example, the UEs 115-d and 115-e may receive messages indicating a set of challenge parameters. Based on the messages, the UEs 115-d and 115-e may determine that the indicated sets of challenge parameters indicate a challenge type and a challenge timing, which may correspond to ceasing radar transmissions within a temporal window (e.g., between T₁ and T₂). That is, upon determining the challenge type and challenge timing, the UE 115-d may cease transmitting a waveform 310-a (e.g., FMCW waveform under coordinated interference) associated with the radar signal 305-a between T₁ and T₂. Similarly, the UE 115-e may cease transmitting a waveform 310-b (e.g., FMCW waveform under coordinated interference) associated with a radar signal 305-b between T₁ and T₂.

Once the UEs 115-d and 115-e initiate the challenge type during the temporal window, each of the UEs 115-d and 115-e may perform sensing to detect possible malicious activity. In some examples, such as those illustrated by FIG. 3, a malicious device (e.g., the UE 115-f) may not receive the indicated set of challenge parameters (e.g., due to encryption). As such, the UE 115-f may continue transmitting a waveform 310-c (e.g., an FMCW waveform to imitate devices operating under coordinated interference), and therefore a radar signal 305-c, during the temporal window. Because the legitimate devices (e.g., the UE 115-d and 115-e) are performing a challenge during the temporal window in accordance with the indicated set of challenge parameters, the UE 115-d, the UE 115-e, or both, may detect the radar signal 305-c during the temporal window. For example, both the UE 115-d and UE 115-e may detect the radar signal 305-c during the temporal window. Based on the detection, the UE 115-d and UE 115-e may both observe that a device is not adhering to the indicated set of challenge parameters.

In some examples, the UE 115-d and UE 115-e may independently determine whether a malicious device is present within the wireless communications system 300. For example, each of the UEs 115-d and 115-e may separately decide to transmit one or more reports to a device within the wireless communications system 300 for fusion and analysis. For example, the UE 115-d, the UE 115-e, or both, may determine whether to report a hard indicator (e.g., a Boolean value of 0 or 1) regarding the presence (e.g., 1) or not (e.g., 0) of an attack by a malicious device in a sensing report. In addition to the hard indicator, a field of view associated with the UEs 115-d, 115-e, or both. Additionally or alternatively, a position associated with the UEs 115-d, 115-e, or both, may be indicated. Additionally or alternatively, a direction associated with a radar component associated with the UEs 115-d, 115-e, or both, may be indicated.

In other examples, the UE 115-d, the UE 115-e, or both, may determine to report a soft indicator regarding an attack by a malicious device, where the soft indicator may be associated with a field of view associated with the UEs 115-d, 115-e, or both, a position associated with the UEs 115-d, 115-e, or both, a direction associated with a radar component of the UEs 115-d, 115-e, or both, or some combination thereof. The soft indicators may correspond to an indicated probability that an attacker is present (e.g., up to the radar implementation to compute the probability using a preconfigured procedure, where the computation may utilize a measured received signal strength indicator (RSSI) associated with the potential malicious device). In some cases, the UEs 115-d and 115-e may include additional information in their respective reports. For example, the UEs 115-d and 115-e may include information such as field of view (e.g., pointing direction), position, and the like, of the sensing radars.

Once the sensing operations have been performed, the UEs 115-d and 115-e may transmit respective reports based on the sensing operations indicating the presence of a malicious device, a probability that a malicious device is present, or both, for use by a device associated with the wireless communications system 300. For example, when the base station 105-b initiated the challenge, the UE 115-d may transmit a report 325 to the base station 105-b over a communication link 320. Additionally, the UE 115-e may transmit a report 335 to the base station 105-b over a communication link 330 (e.g., uplink or sidelink), where the base station 105-b may perform one or more fusing operations to determine if a malicious device is present. In such cases, the transmissions from the UEs 115-d and 115-e may correspond to unicast uplink transmissions (e.g., over the communication links 320 and 330).

In other examples, such as in cases where the UEs 115-d and 115-e initiate the challenge autonomously (e.g., when out of coverage of the base station 105-b), the UEs 115-d and 115-e may report observations (e.g., via the sensing report) associated with the sensing operations over sidelink (e.g., via a communication link 345). For example, the UE 115-e may transmit a report via groupcast or broadcast message such that all radars may form an understanding of whether there is an ongoing attack and how to take appropriate actions. In other examples, such as those illustrated in FIG. 3, the UEs 115-d and 115-e may transmit the report based on which device initiated the challenge. For example, the UE 115-e may transmit a report 340 over the communication link 345, via unicast, in response to a challenge initiated by the UE 115-d. The UE 115-d may fuse the report 340 with observations made by the UE 115-d during the sensing operation.

Whether the reports are aggregated at the base station 105-b, at an initiating UE (e.g., the UE 115-d), or broadcasted throughout the wireless communications system 300, one or more receiving entities may fuse the reports to determine if a malicious device is present. For example, the UE 115-d may fuse the report 340 with observations made at the UE 115-d to determine if a malicious device is present. Additionally or alternatively, the UE 115-d may determine its pointing direction, as well as a pointing direction associated with the UE 115-e to determine an approximate location of the malicious device. For example, if all (or most) radars facing towards the same direction detect malicious activity, then the fusing device (e.g., the UE 115-d) may determine, with high probability, that an attack is originating from that direction. Based on the determination, the UE 115-d may report fusion results to the wireless communications system 300 in a follow up message. In some examples, in the case where an attack is detected, the follow up report may indicate one or more recommended actions.

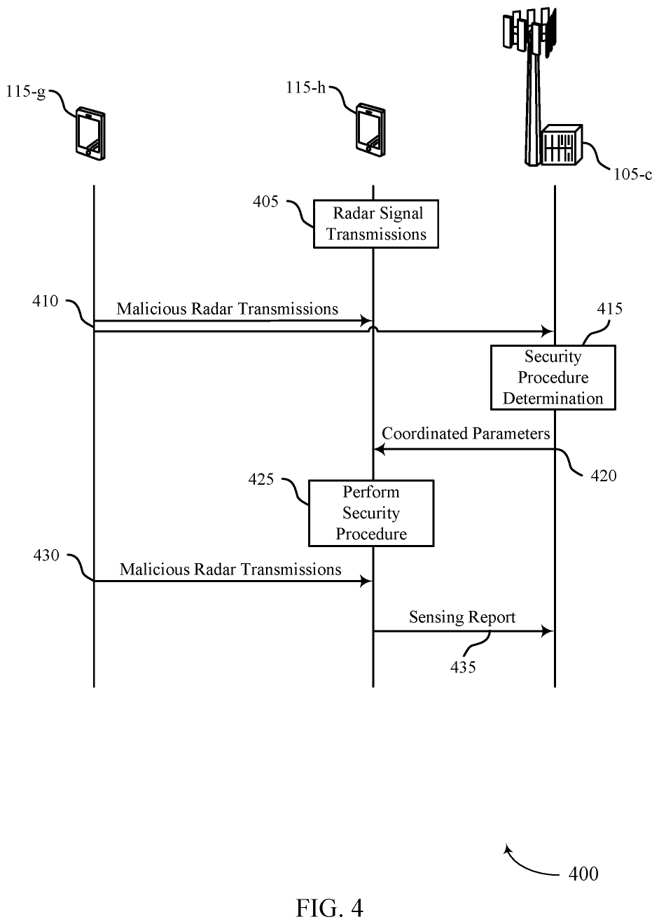

FIG. 4 illustrates an example of a process flow 400 that supports coordinated detection of spoofing attacks in multi-radar coordinated interference operation in accordance with aspects of the present disclosure. The process flow 400 may be implemented by one or more wireless devices, such as a UE 115-g, a UE 115-h, and a base station 105-c, which may be an example of the corresponding devices described herein. In some examples, the process flow 400 may include one or more operations and procedures associated with the base station 105-c and UEs 115-g and 115-h, which may be examples of and the corresponding devices described herein. While specific operations may be discussed below, the operations may be performed in a different order than the example order shown, or the operations performed by the devices may be performed by different devices or at different times.

At 405, the UE 115-h (e.g., a legitimate UE in communication with the base station 105-c) may perform radar signal transmissions during associated operations. For example, the UE 115-h may correspond to a vehicle performing radar sensing operations in support of autonomous driving operations within a C-V2X system.

At 410, a malicious device (e.g., the UE 115-g) may perform malicious radar transmissions, which may be received by the UE 115-h. In some examples, such as those described with reference to FIG. 3, the UE 115-h may determine to trigger a security procedure. In other cases, the base station 105-c may determine to initiate the security procedure.

At 415, for example, the base station 105-c may perform a security procedure determination based on the malicious radar transmissions my the malicious device. Based on the determination to perform a security procedure, the base station 105-c may determine a challenge type, a challenge interval, or both, associated with the security procedure.

At 420, the base station 105-c may transmit coordinated parameters associated with the security procedure to the UE 115-h. For example, the base station 105-c may indicate a challenge type (e.g., refraining from transmitting radar signals), timing information associated with the challenge type (e.g., a start time, end time, duration, periodicity, number of frames, and the like associated with the challenge), or both.

At 425, the UE 115-h may perform the security procedure according to the coordinated parameters transmitted by the base station 105-c. At 430, the UE 115-h may receive malicious radar transmissions during the challenge. Based on receiving the malicious radar transmissions, the UE 115-h may determine that a malicious device is present. At 435, based on receiving the malicious radar transmissions, the UE 115-h may transmit a sensing report (e.g., including a hard indicator, soft indicator, or both) to the base station 105-c indicating a presence of the malicious device, a field of view associated with the UE 115-h, a position associated with the UE 115-h, a radar direction associated with the UE 115-h, or any combination thereof.

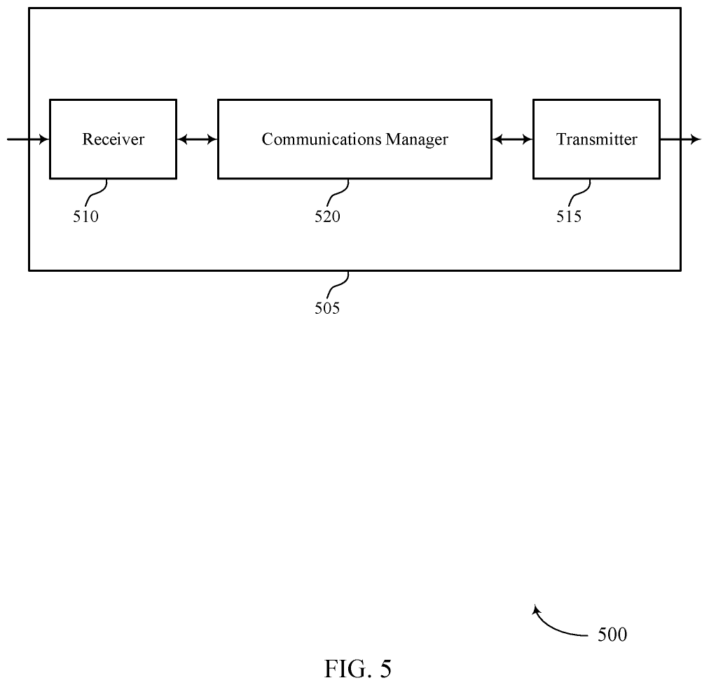

FIG. 5 shows a block diagram 500 of a device 505 that supports coordinated detection of spoofing attacks in multi-radar coordinated interference operation in accordance with aspects of the present disclosure. The device 505 may be an example of aspects of a UE as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to coordinated detection of spoofing attacks in multi-radar coordinated interference operation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to coordinated detection of spoofing attacks in multi-radar coordinated interference operation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of coordinated detection of spoofing attacks in multi-radar coordinated interference operation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, one or more instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for transmitting, by the UE operating in a first detection mode, a first set of radar signals in accordance with a first set of operating parameters for radar signaling. The communications manager 520 may be configured as or otherwise support a means for switching from the first detection mode to a second detection mode associated with a second set of coordinated operating parameters for radar signaling, the second set of coordinated operating parameters associated with the UE and one or more wireless devices in coordination with the UE. The communications manager 520 may be configured as or otherwise support a means for performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources by detecting a presence associated with a malicious device, which may reduce interference experienced at the device 505 and improve overall performance.

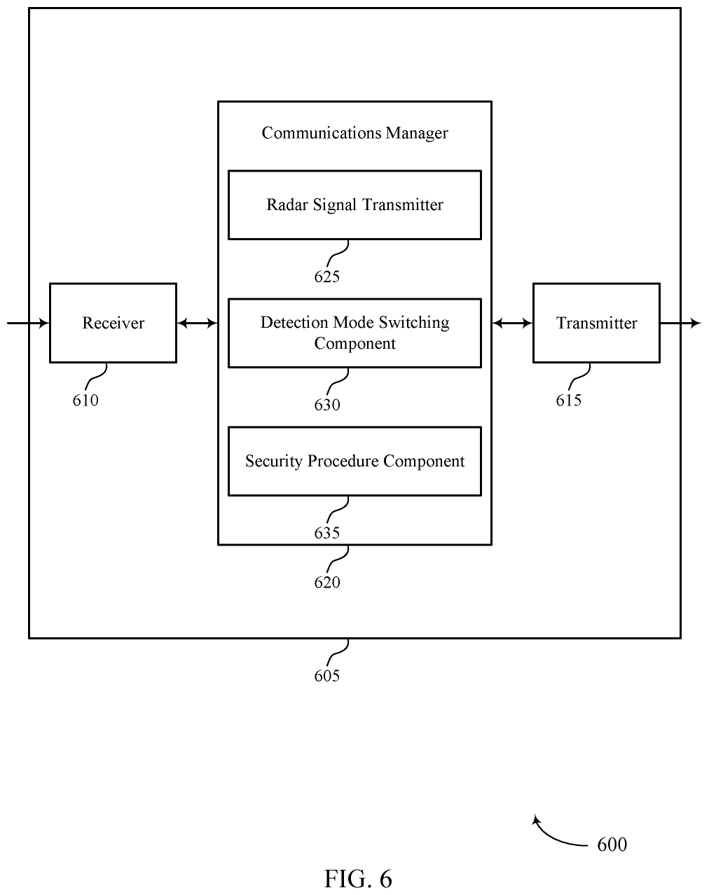

FIG. 6 shows a block diagram 600 of a device 605 that supports coordinated detection of spoofing attacks in multi-radar coordinated interference operation in accordance with aspects of the present disclosure. The device 605 may be an example of aspects of a device 505 or a UE as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to coordinated detection of spoofing attacks in multi-radar coordinated interference operation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to coordinated detection of spoofing attacks in multi-radar coordinated interference operation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of coordinated detection of spoofing attacks in multi-radar coordinated interference operation as described herein. For example, the communications manager 620 may include a radar signal transmitter 625, a detection mode switching component 630, a security procedure component 635, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The radar signal transmitter 625 may be configured as or otherwise support a means for transmitting, by the UE operating in a first detection mode, a first set of radar signals in accordance with a first set of operating parameters for radar signaling. The detection mode switching component 630 may be configured as or otherwise support a means for switching from the first detection mode to a second detection mode associated with a second set of coordinated operating parameters for radar signaling, the second set of coordinated operating parameters associated with the UE and one or more wireless devices in coordination with the UE. The security procedure component 635 may be configured as or otherwise support a means for performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

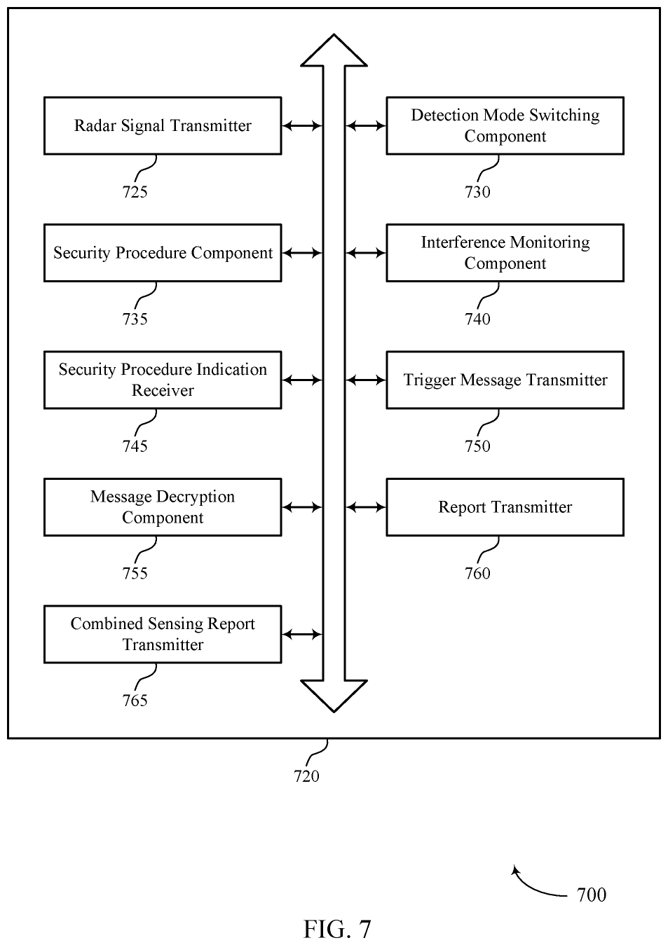

FIG. 7 shows a block diagram 700 of a communications manager 720 that supports coordinated detection of spoofing attacks in multi-radar coordinated interference operation in accordance with aspects of the present disclosure. The communications manager 720 may be an example of aspects of a communications manager 520, a communications manager 620, or both, as described herein. The communications manager 720, or various components thereof, may be an example of means for performing various aspects of coordinated detection of spoofing attacks in multi-radar coordinated interference operation as described herein. For example, the communications manager 720 may include a radar signal transmitter 725, a detection mode switching component 730, a security procedure component 735, an interference monitoring component 740, a security procedure indication receiver 745, a trigger message transmitter 750, a message decryption component 755, a report transmitter 760, a combined sensing report transmitter 765, or any combination thereof. Each of these components may communicate, directly or indirectly, with one another (e.g., via one or more buses).

The communications manager 720 may support wireless communications at a UE in accordance with examples as disclosed herein. The radar signal transmitter 725 may be configured as or otherwise support a means for transmitting, by the UE operating in a first detection mode, a first set of radar signals in accordance with a first set of operating parameters for radar signaling. The detection mode switching component 730 may be configured as or otherwise support a means for switching from the first detection mode to a second detection mode associated with a second set of coordinated operating parameters for radar signaling, the second set of coordinated operating parameters associated with the UE and one or more wireless devices in coordination with the UE. The security procedure component 735 may be configured as or otherwise support a means for performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

In some examples, to support performing the security procedure, the security procedure component 735 may be configured as or otherwise support a means for refraining from transmitting radar signals during the challenge interval. In some examples, to support performing the security procedure, the interference monitoring component 740 may be configured as or otherwise support a means for monitoring for one or more interfering radar signals from the interfering wireless device during the challenge interval.

In some examples, to support performing the security procedure, the radar signal transmitter 725 may be configured as or otherwise support a means for transmitting, during the challenge interval, a second set of radar signals in accordance with the second set of coordinated operating parameters.

In some examples, the security procedure indication receiver 745 may be configured as or otherwise support a means for receiving, from a wireless device, an indication of the security procedure for detecting the interfering wireless device, the indication of the security procedure indicating a type of challenge for the security procedure, timing information for the security procedure, or any combination thereof, where the timing information includes a start time associated with the security procedure, a number of frames for the security procedure, an end time of the security procedure, one or more challenge intervals for the security procedure, a duration of the challenge interval, or any combination thereof.

In some examples, to support receiving the indication of the security procedure, the security procedure indication receiver 745 may be configured as or otherwise support a means for receiving the indication of the security procedure via a groupcast message for a group of wireless devices including the UE and the one or more wireless devices or a unicast message for the UE.

In some examples, to support receiving the indication of the security procedure, the security procedure indication receiver 745 may be configured as or otherwise support a means for receiving an encrypted message including the indication of the security procedure. In some examples, to support receiving the indication of the security procedure, the message decryption component 755 may be configured as or otherwise support a means for decrypting the encrypted message based on an encryption key associated with the UE and the one or more wireless devices in coordination with the UE.

In some examples, to support performing the security procedure, the security procedure component 735 may be configured as or otherwise support a means for performing the security procedure at the start time indicated by the timing information and during the number of frames indicated by the timing information.

In some examples, the security procedure includes a default security procedure or a fallback security procedure.

In some examples, to support performing the security procedure, the security procedure component 735 may be configured as or otherwise support a means for performing the security procedure according to a periodicity for the security procedure, where the second set of coordinated operating parameters includes a waveform different from the first set of operating parameters.

In some examples, the timing information includes random timing information indicating an aperiodicity associated with the security procedure.

In some examples, to support performing the security procedure, the interference monitoring component 740 may be configured as or otherwise support a means for monitoring a set of radar resources for one or more radar signals in accordance with the sensing procedure. In some examples, to support performing the security procedure, the report transmitter 760 may be configured as or otherwise support a means for transmitting a report indicating one or more measurement results of the sensing procedure based on the monitoring.

In some examples, the one or more measurement results includes a hard indicator corresponding to whether the interfering wireless device is present or a soft indicator corresponding to whether the interfering wireless device is present, a field of view associated with the UE, a position of the UE, a direction associated with a radar component of the UE, or any combination thereof.

In some examples, the hard indicator includes a Boolean value associated with whether the interfering wireless device is present based on the monitoring and the soft indicator includes a probability associated with whether the interfering wireless device is present, a signal strength associated with the one or more radar signals based on the monitoring, or any combination thereof.

In some examples, the report is transmitted to a base station via an uplink message, a sidelink message, or both, to at least one wireless device of the one or more wireless devices via a sidelink message, to the one or more wireless devices via a groupcast message or a broadcast message, or any combination thereof.

In some examples, the trigger message transmitter 750 may be configured as or otherwise support a means for transmitting a trigger message to at least one wireless device of the one or more wireless devices, where the trigger message instructs the at least one wireless device to perform a corresponding security procedure during the challenge interval.

In some examples, to support transmitting the trigger message, the trigger message transmitter 750 may be configured as or otherwise support a means for transmitting an encrypted message including the trigger message via a broadcast message to the one or more wireless devices, a groupcast message to a group of wireless devices including the at least one wireless device, a unicast message to the at least one wireless device, or any combination thereof.

In some examples, to support corresponding security procedure, the security procedure component 735 may be configured as or otherwise support a means for a request to apply a same security procedure as the UE during the challenge interval, to remain silent during the challenge interval, to perform a sensing procedure for the security procedure during the challenge interval, to report sensing results associated with the sensing procedure, or any combination thereof.

In some examples, the request includes a request type, the request type including on of an optional request or a mandatory request.

In some examples, the corresponding security procedure includes the request to report sensing results associated with the sensing procedure, and the security procedure indication receiver 745 may be configured as or otherwise support a means for receiving, from the at least one wireless device, a sensing report, a hard indicator, a soft indicator, or some combination thereof, indicating one or more sensing results of the sensing procedure at the at least one wireless device. In some examples, the corresponding security procedure includes the request to report sensing results associated with the sensing procedure, and the combined sensing report transmitter 765 may be configured as or otherwise support a means for transmitting a combined sensing report to a wireless device, the combined sensing report, the hard indicator, the soft indicator, or some combination thereof, including the one or more sensing results and at least one additional sensing result.

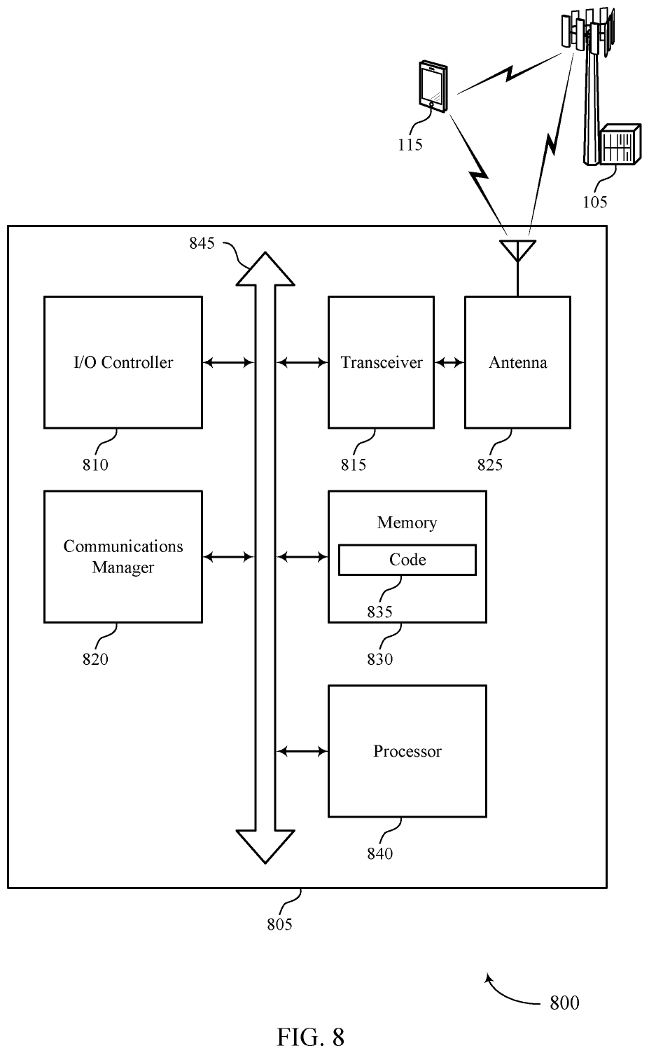

FIG. 8 shows a diagram of a system 800 including a device 805 that supports coordinated detection of spoofing attacks in multi-radar coordinated interference operation in accordance with aspects of the present disclosure. The device 805 may be an example of or include the components of a device 505, a device 605, or a UE as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting coordinated detection of spoofing attacks in multi-radar coordinated interference operation). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for transmitting, by the UE operating in a first detection mode, a first set of radar signals in accordance with a first set of operating parameters for radar signaling. The communications manager 820 may be configured as or otherwise support a means for switching from the first detection mode to a second detection mode associated with a second set of coordinated operating parameters for radar signaling, the second set of coordinated operating parameters associated with the UE and one or more wireless devices in coordination with the UE. The communications manager 820 may be configured as or otherwise support a means for performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

By including or configuring the communications manager 820 in accordance with examples as described herein, the device 805 may support techniques for improved communication reliability, reduced latency, improved user experience related to reduced processing, and improved coordination between devices by utilizing security procedures to mitigate interference due to malicious devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of coordinated detection of spoofing attacks in multi-radar coordinated interference operation as described herein, or the processor 840 and the memory 830 may be otherwise configured to perform or support such operations.

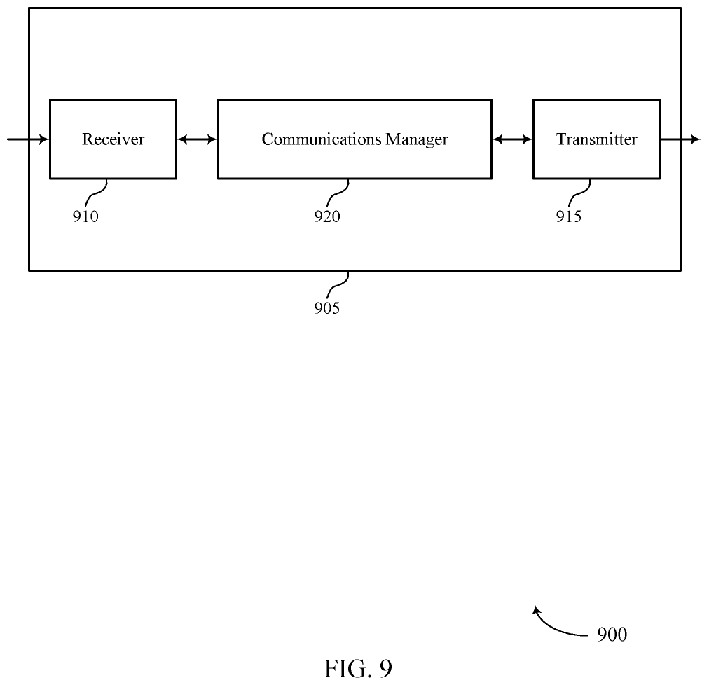

FIG. 9 shows a block diagram 900 of a device 905 that supports coordinated detection of spoofing attacks in multi-radar coordinated interference operation in accordance with aspects of the present disclosure. The device 905 may be an example of aspects of a Base station as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to coordinated detection of spoofing attacks in multi-radar coordinated interference operation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to coordinated detection of spoofing attacks in multi-radar coordinated interference operation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of coordinated detection of spoofing attacks in multi-radar coordinated interference operation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, one or more instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a wireless device in accordance with examples as disclosed herein. For example, the communications manager 920 may be configured as or otherwise support a means for selecting a type of challenge, timing information, or both for a security procedure for detecting an interfering wireless device within a radar system. The communications manager 920 may be configured as or otherwise support a means for transmitting, to a UE, an indication of the security procedure for detecting the interfering wireless device, the indication of the security procedure indicating the type of challenge for the security procedure, the timing information for the security procedure, or both. The communications manager 920 may be configured as or otherwise support a means for monitoring a set of radar resources for one or more messages during a challenge interval associated with the security procedure based on the indication of the security procedure.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reduced processing, reduced power consumption, and more efficient utilization of communication resources by detecting a presence associated with a malicious device, which may reduce interference experienced at the device 905 and improve overall performance.

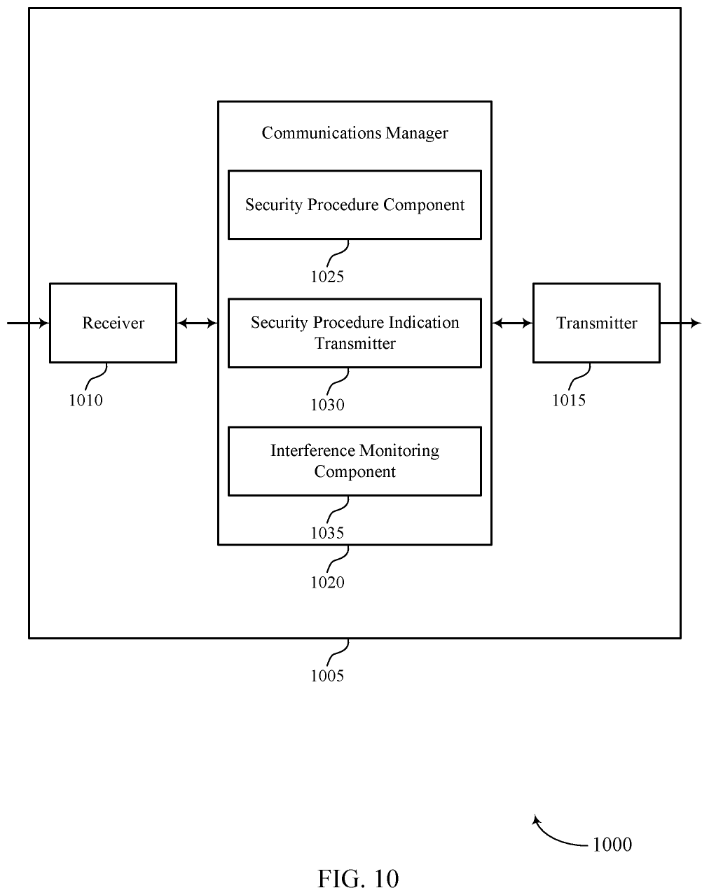

FIG. 10 shows a block diagram 1000 of a device 1005 that supports coordinated detection of spoofing attacks in multi-radar coordinated interference operation in accordance with aspects of the present disclosure. The device 1005 may be an example of aspects of a device 905 or a Base station 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to coordinated detection of spoofing attacks in multi-radar coordinated interference operation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to coordinated detection of spoofing attacks in multi-radar coordinated interference operation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of coordinated detection of spoofing attacks in multi-radar coordinated interference operation as described herein. For example, the communications manager 1020 may include a security procedure component 1025, a security procedure indication transmitter 1030, an interference monitoring component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a wireless device in accordance with examples as disclosed herein. The security procedure component 1025 may be configured as or otherwise support a means for selecting a type of challenge, timing information, or both for a security procedure for detecting an interfering wireless device within a radar system. The security procedure indication transmitter 1030 may be configured as or otherwise support a means for transmitting, to a UE, an indication of the security procedure for detecting the interfering wireless device, the indication of the security procedure indicating the type of challenge for the security procedure, the timing information for the security procedure, or both. The interference monitoring component 1035 may be configured as or otherwise support a means for monitoring a set of radar resources for one or more messages during a challenge interval associated with the security procedure based on the indication of the security procedure.

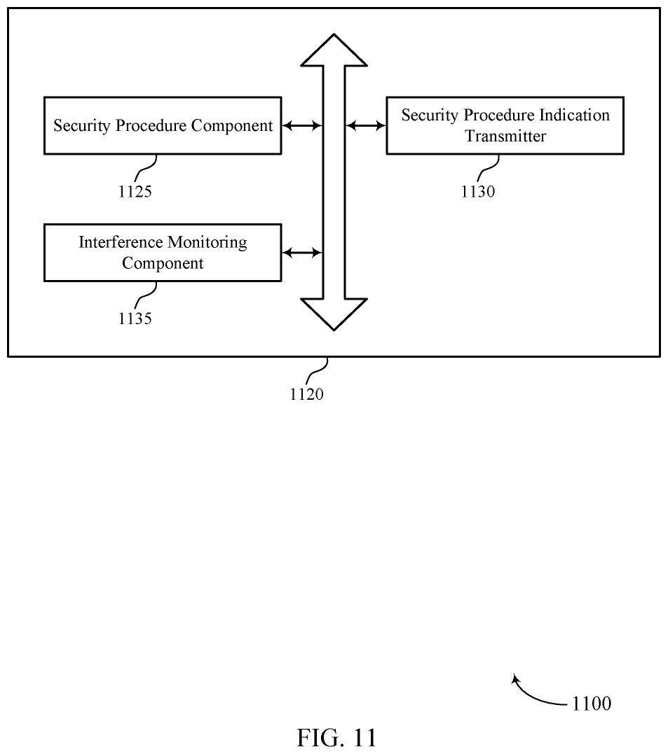

FIG. 11 shows a block diagram 1100 of a communications manager 1120 that supports coordinated detection of spoofing attacks in multi-radar coordinated interference operation in accordance with aspects of the present disclosure. The communications manager 1120 may be an example of aspects of a communications manager 920, a communications manager 1020, or both, as described herein. The communications manager 1120, or various components thereof, may be an example of means for performing various aspects of coordinated detection of spoofing attacks in multi-radar coordinated interference operation as described herein. For example, the communications manager 1120 may include a security procedure component 1125, a security procedure indication transmitter 1130, an interference monitoring component 1135, or any combination thereof. Each of these components may communicate, directly or indirectly, with one another (e.g., via one or more buses).

The communications manager 1120 may support wireless communications at a wireless device in accordance with examples as disclosed herein. The security procedure component 1125 may be configured as or otherwise support a means for selecting a type of challenge, timing information, or both for a security procedure for detecting an interfering wireless device within a radar system. The security procedure indication transmitter 1130 may be configured as or otherwise support a means for transmitting, to a UE, an indication of the security procedure for detecting the interfering wireless device, the indication of the security procedure indicating the type of challenge for the security procedure, the timing information for the security procedure, or both. The interference monitoring component 1135 may be configured as or otherwise support a means for monitoring a set of radar resources for one or more messages during a challenge interval associated with the security procedure based on the indication of the security procedure.

In some examples, to support transmitting the indication of the security procedure, the security procedure indication transmitter 1130 may be configured as or otherwise support a means for transmitting a groupcast message to a group of wireless devices including the UE and one or more wireless devices in coordination with the UE, where the groupcast message includes the indication of the security procedure.

In some examples, to support transmitting the indication of the security procedure, the security procedure indication transmitter 1130 may be configured as or otherwise support a means for transmitting a unicast message for the UE, where the unicast message includes the indication of the security procedure.

In some examples, to support transmitting the indication of the security procedure, the security procedure indication transmitter 1130 may be configured as or otherwise support a means for transmitting an encrypted message including the indication of the security procedure, where the encrypted message is encrypted based on an encryption key associated with the UE and one or more wireless devices in coordination with the UE.

In some examples, to support transmitting the indication of the security procedure, the security procedure indication transmitter 1130 may be configured as or otherwise support a means for transmitting a sensing procedure indication to the UE, where the sensing procedure indication includes a request to report sensing results for a sensing procedure associated with the security procedure, an indication of whether the UE is to detect the interfering wireless device, or a combination thereof.

In some examples, the interference monitoring component 1135 may be configured as or otherwise support a means for monitoring for one or more sensing reports based on the sensing procedure indication.

In some examples, the security procedure component 1125 may be configured as or otherwise support a means for selecting the UE from a set of wireless devices of the radar system based on a position of the UE, a radar direction of the UE, a transmit power associated with the UE, or any combination thereof.

In some examples, to support selecting the type of challenge, the timing information, or both for the security procedure, the security procedure component 1125 may be configured as or otherwise support a means for randomly selecting the type of challenge, the timing information, or both for the security procedure.

In some examples, the timing information includes a start time associated with the security procedure, a number of frames for the security procedure, an end time of the security procedure, one or more challenge intervals for the security procedure, a duration of the challenge interval, a periodicity for the security procedure, or any combination thereof.

In some examples, the type of challenge instructs the UE to remain silent for a duration of the challenge interval.

In some examples, the type of challenge instructs the UE to transmit radar signals according to a set of operating parameters for the security procedure for a duration of the challenge interval.

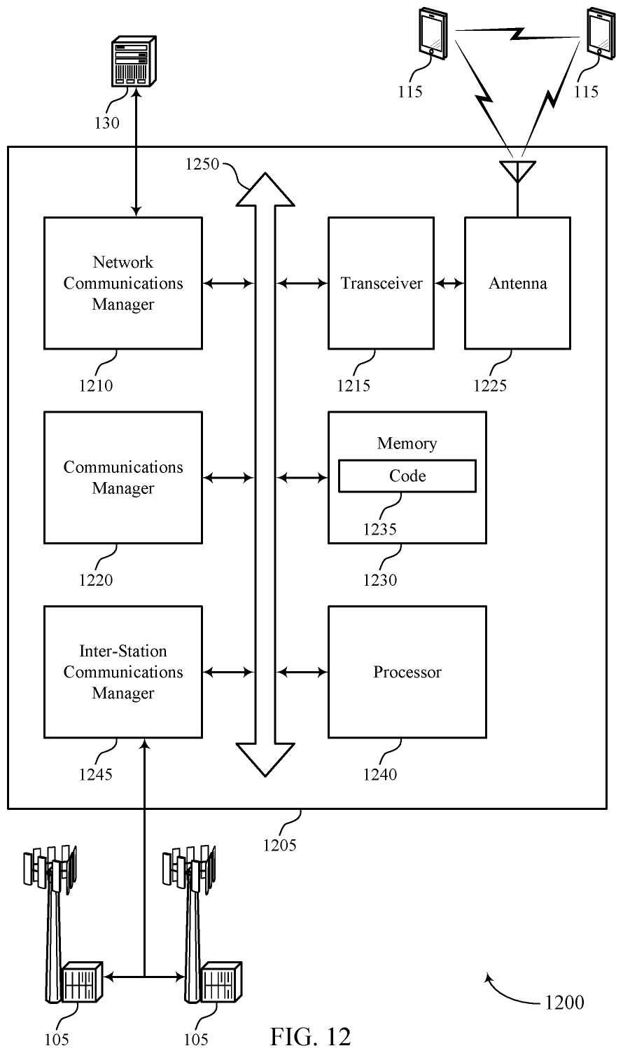

FIG. 12 shows a diagram of a system 1200 including a device 1205 that supports coordinated detection of spoofing attacks in multi-radar coordinated interference operation in accordance with aspects of the present disclosure. The device 1205 may be an example of or include the components of a device 905, a device 1005, or a Base station as described herein. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting coordinated detection of spoofing attacks in multi-radar coordinated interference operation). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a wireless device in accordance with examples as disclosed herein. For example, the communications manager 1220 may be configured as or otherwise support a means for selecting a type of challenge, timing information, or both for a security procedure for detecting an interfering wireless device within a radar system. The communications manager 1220 may be configured as or otherwise support a means for transmitting, to a UE, an indication of the security procedure for detecting the interfering wireless device, the indication of the security procedure indicating the type of challenge for the security procedure, the timing information for the security procedure, or both. The communications manager 1220 may be configured as or otherwise support a means for monitoring a set of radar resources for one or more messages during a challenge interval associated with the security procedure based on the indication of the security procedure.

By including or configuring the communications manager 1220 in accordance with examples as described herein, the device 1205 may support techniques for improved communication reliability, reduced latency, improved user experience related to reduced processing, and improved coordination between devices by utilizing security procedures to mitigate interference due to malicious devices.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of coordinated detection of spoofing attacks in multi-radar coordinated interference operation as described herein, or the processor 1240 and the memory 1230 may be otherwise configured to perform or support such operations.

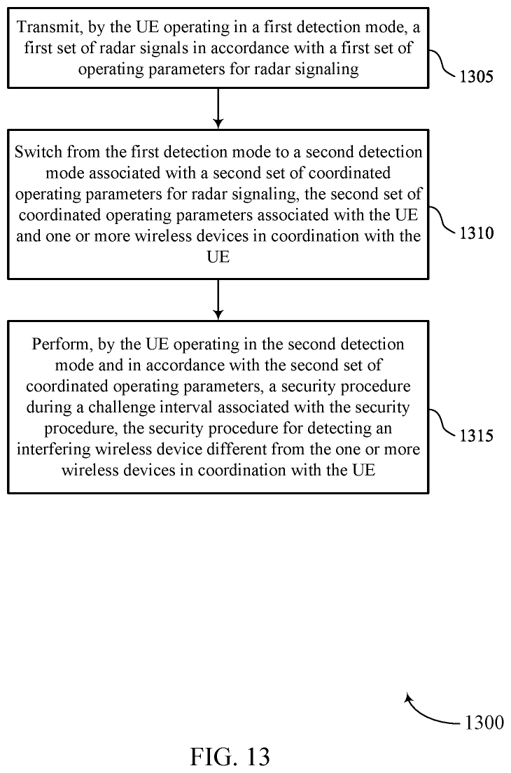

FIG. 13 shows a flowchart illustrating a method 1300 that supports coordinated detection of spoofing attacks in multi-radar coordinated interference operation in accordance with aspects of the present disclosure. The operations of the method 1300 may be implemented by a UE or its components as described herein. For example, the operations of the method 1300 may be performed by a UE as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include transmitting, by the UE operating in a first detection mode, a first set of radar signals in accordance with a first set of operating parameters for radar signaling. The operations of 1305 may be performed in accordance with examples as disclosed herein. In some examples, aspects of the operations of 1305 may be performed by a radar signal transmitter 725 as described with reference to FIG. 7.

At 1310, the method may include switching from the first detection mode to a second detection mode associated with a second set of coordinated operating parameters for radar signaling, the second set of coordinated operating parameters associated with the UE and one or more wireless devices in coordination with the UE. The operations of 1310 may be performed in accordance with examples as disclosed herein. In some examples, aspects of the operations of 1310 may be performed by a detection mode switching component 730 as described with reference to FIG. 7.

At 1315, the method may include performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE. The operations of 1315 may be performed in accordance with examples as disclosed herein. In some examples, aspects of the operations of 1315 may be performed by a security procedure component 735 as described with reference to FIG. 7.

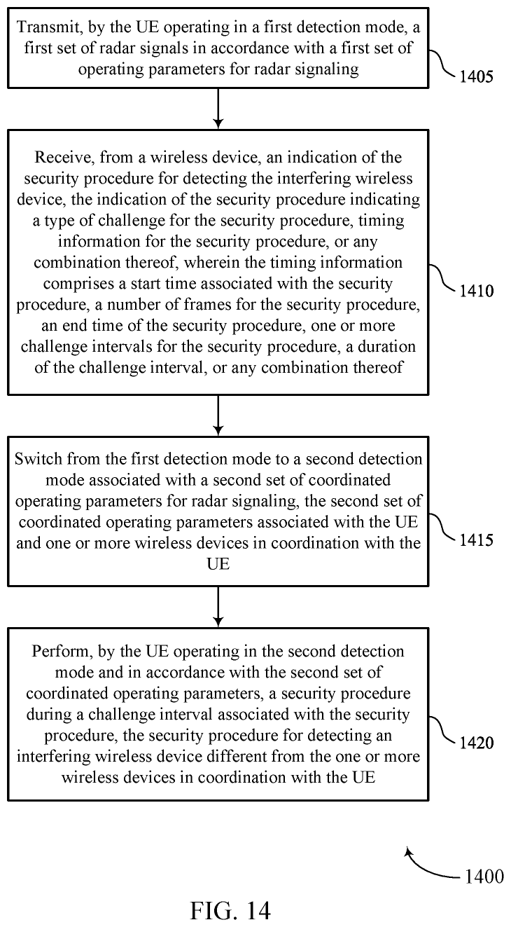

FIG. 14 shows a flowchart illustrating a method 1400 that supports coordinated detection of spoofing attacks in multi-radar coordinated interference operation in accordance with aspects of the present disclosure. The operations of the method 1400 may be implemented by a UE or its components as described herein. For example, the operations of the method 1400 may be performed by a UE as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include transmitting, by the UE operating in a first detection mode, a first set of radar signals in accordance with a first set of operating parameters for radar signaling. The operations of 1405 may be performed in accordance with examples as disclosed herein. In some examples, aspects of the operations of 1405 may be performed by a radar signal transmitter 725 as described with reference to FIG. 7.

At 1410, the method may include receiving, from a wireless device, an indication of the security procedure for detecting the interfering wireless device, the indication of the security procedure indicating a type of challenge for the security procedure, timing information for the security procedure, or any combination thereof, where the timing information includes a start time associated with the security procedure, a number of frames for the security procedure, an end time of the security procedure, one or more challenge intervals for the security procedure, a duration of the challenge interval, or any combination thereof. The operations of 1410 may be performed in accordance with examples as disclosed herein. In some examples, aspects of the operations of 1410 may be performed by a security procedure indication receiver 745 as described with reference to FIG. 7.

At 1415, the method may include switching from the first detection mode to a second detection mode associated with a second set of coordinated operating parameters for radar signaling, the second set of coordinated operating parameters associated with the UE and one or more wireless devices in coordination with the UE. The operations of 1415 may be performed in accordance with examples as disclosed herein. In some examples, aspects of the operations of 1415 may be performed by a detection mode switching component 730 as described with reference to FIG. 7.

At 1420, the method may include performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE. The operations of 1420 may be performed in accordance with examples as disclosed herein. In some examples, aspects of the operations of 1420 may be performed by a security procedure component 735 as described with reference to FIG. 7.

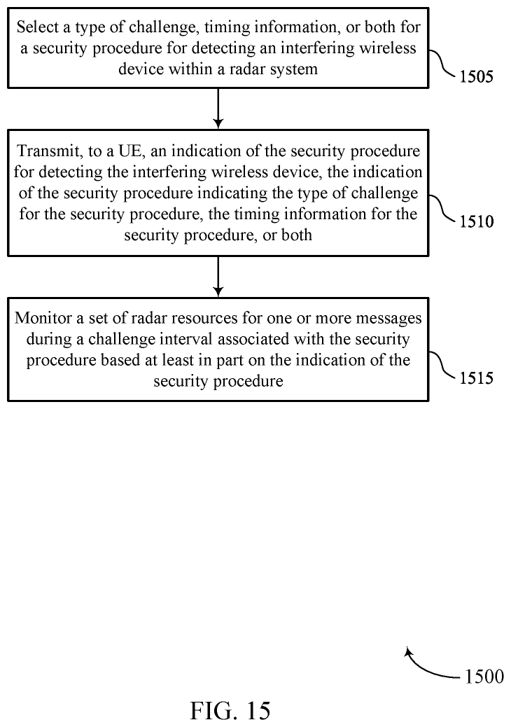

FIG. 15 shows a flowchart illustrating a method 1500 that supports coordinated detection of spoofing attacks in multi-radar coordinated interference operation in accordance with aspects of the present disclosure. The operations of the method 1500 may be implemented by a Base station or its components as described herein. For example, the operations of the method 1500 may be performed by a Base station as described with reference to FIGS. 1 through 4 and 9 through 12. In some examples, a Base station may execute a set of instructions to control the functional elements of the Base station to perform the described functions. Additionally or alternatively, the Base station may perform aspects of the described functions using special-purpose hardware.

At 1505, the method may include selecting a type of challenge, timing information, or both for a security procedure for detecting an interfering wireless device within a radar system. The operations of 1505 may be performed in accordance with examples as disclosed herein. In some examples, aspects of the operations of 1505 may be performed by a security procedure component 1125 as described with reference to FIG. 11.

At 1510, the method may include transmitting, to a UE, an indication of the security procedure for detecting the interfering wireless device, the indication of the security procedure indicating the type of challenge for the security procedure, the timing information for the security procedure, or both. The operations of 1510 may be performed in accordance with examples as disclosed herein. In some examples, aspects of the operations of 1510 may be performed by a security procedure indication transmitter 1130 as described with reference to FIG. 11.

At 1515, the method may include monitoring a set of radar resources for one or more messages during a challenge interval associated with the security procedure based on the indication of the security procedure. The operations of 1515 may be performed in accordance with examples as disclosed herein. In some examples, aspects of the operations of 1515 may be performed by an interference monitoring component 1135 as described with reference to FIG. 11.

The following provides an overview of aspects of the present disclosure:

Aspect 1: A method for wireless communications at a UE, comprising: transmitting, by the UE operating in a first detection mode, a first set of radar signals in accordance with a first set of operating parameters for radar signaling; switching from the first detection mode to a second detection mode associated with a second set of coordinated operating parameters for radar signaling, the second set of coordinated operating parameters associated with the UE and one or more wireless devices in coordination with the UE; and performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

Aspect 2: The method of aspect 1, wherein performing the security procedure comprises: refraining from transmitting radar signals during the challenge interval; and monitoring for one or more interfering radar signals from the interfering wireless device during the challenge interval.

Aspect 3: The method of any of aspects 1 through 2, wherein performing the security procedure comprises: transmitting, during the challenge interval, a second set of radar signals in accordance with the second set of coordinated operating parameters.

Aspect 4: The method of any of aspects 1 through 3, further comprising: receiving, from a wireless device, an indication of the security procedure for detecting the interfering wireless device, the indication of the security procedure indicating a type of challenge for the security procedure, timing information for the security procedure, or any combination thereof, wherein the timing information comprises a start time associated with the security procedure, a number of frames for the security procedure, an end time of the security procedure, one or more challenge intervals for the security procedure, a duration of the challenge interval, or any combination thereof.

Aspect 5: The method of aspect 4, wherein receiving the indication of the security procedure comprises: receiving the indication of the security procedure via a groupcast message for a group of wireless devices including the UE and the one or more wireless devices or a unicast message for the UE.

Aspect 6: The method of any of aspects 4 through 5, wherein receiving the indication of the security procedure comprises: receiving an encrypted message comprising the indication of the security procedure; and decrypting the encrypted message based at least in part on an encryption key associated with the UE and the one or more wireless devices in coordination with the UE.

Aspect 7: The method of any of aspects 4 through 6, wherein the indication of the security procedure indicates the timing information for the security procedure, wherein performing the security procedure comprises: performing the security procedure at the start time indicated by the timing information and during the number of frames indicated by the timing information.

Aspect 8: The method of aspect 7, wherein the security procedure comprises a default security procedure or a fallback security procedure.

Aspect 9: The method of any of aspects 4 through 8, wherein the indication of the security procedure indicates the type of challenge for the security procedure, wherein performing the security procedure comprises: performing the security procedure according to a periodicity for the security procedure, wherein the second set of coordinated operating parameters comprises a waveform different from the first set of operating parameters.

Aspect 10: The method of any of aspects 4 through 9, wherein the timing information comprises random timing information indicating an aperiodicity associated with the security procedure.

Aspect 11: The method of any of aspects 4 through 10, wherein the indication of the security procedure indicates a sensing procedure for the security procedure, wherein performing the security procedure comprises: monitoring a set of radar resources for one or more radar signals in accordance with the sensing procedure; and transmitting a report indicating one or more measurement results of the sensing procedure based at least in part on the monitoring.

Aspect 12: The method of aspect 11, wherein the one or more measurement results comprises a hard indicator corresponding to whether the interfering wireless device is present or a soft indicator corresponding to whether the interfering wireless device is present, a field of view associated with the UE, a position of the UE, a direction associated with a radar component of the UE, or any combination thereof.

Aspect 13: The method of aspect 12, wherein the hard indicator comprises a Boolean value associated with whether the interfering wireless device is present based at least in part on the monitoring and the soft indicator comprises a probability associated with whether the interfering wireless device is present, a signal strength associated with the one or more radar signals based at least in part on the monitoring, or any combination thereof.

Aspect 14: The method of any of aspects 11 through 13, wherein the report is transmitted to a base station via an uplink message, a sidelink message, or both, to at least one wireless device of the one or more wireless devices via a sidelink message, to the one or more wireless devices via a groupcast message or a broadcast message, or any combination thereof.

Aspect 15: The method of any of aspects 1 through 14, further comprising: transmitting a trigger message to at least one wireless device of the one or more wireless devices, wherein the trigger message instructs the at least one wireless device to perform a corresponding security procedure during the challenge interval.

Aspect 16: The method of aspect 15, wherein transmitting the trigger message comprises: transmitting an encrypted message comprising the trigger message via a broadcast message to the one or more wireless devices, a groupcast message to a group of wireless devices including the at least one wireless device, a unicast message to the at least one wireless device, or any combination thereof.

Aspect 17: The method of any of aspects 15 through 16, wherein the corresponding security procedure comprises: a request to apply a same security procedure as the UE during the challenge interval, to remain silent during the challenge interval, to perform a sensing procedure for the security procedure during the challenge interval, to report sensing results associated with the sensing procedure, or any combination thereof.

Aspect 18: The method of aspect 17, wherein the request comprises a request type, the request type comprising on of an optional request or a mandatory request.

Aspect 19: The method of any of aspects 17 through 18, wherein the corresponding security procedure comprises the request to report sensing results associated with the sensing procedure, the method further comprising: receiving, from the at least one wireless device, a sensing report, a hard indicator, a soft indicator, or some combination thereof, indicating one or more sensing results of the sensing procedure at the at least one wireless device; and transmitting a combined sensing report to a wireless device, the combined sensing report, the hard indicator, the soft indicator, or some combination thereof, including the one or more sensing results and at least one additional sensing result.

Aspect 20: A method for wireless communications at a wireless device, comprising: selecting a type of challenge, timing information, or both for a security procedure for detecting an interfering wireless device within a radar system; transmitting, to a UE, an indication of the security procedure for detecting the interfering wireless device, the indication of the security procedure indicating the type of challenge for the security procedure, the timing information for the security procedure, or both; and monitoring a set of radar resources for one or more messages during a challenge interval associated with the security procedure based at least in part on the indication of the security procedure.

Aspect 21: The method of aspect 20, wherein transmitting the indication of the security procedure comprises: transmitting a groupcast message to a group of wireless devices including the UE and one or more wireless devices in coordination with the UE, wherein the groupcast message comprises the indication of the security procedure.

Aspect 22: The method of any of aspects 20 through 21, wherein transmitting the indication of the security procedure comprises: transmitting a unicast message for the UE, wherein the unicast message comprises the indication of the security procedure.

Aspect 23: The method of any of aspects 20 through 22, wherein transmitting the indication of the security procedure comprises: transmitting an encrypted message comprising the indication of the security procedure, wherein the encrypted message is encrypted based at least in part on an encryption key associated with the UE and one or more wireless devices in coordination with the UE.

Aspect 24: The method of any of aspects 20 through 23, wherein transmitting the indication of the security procedure comprises: transmitting a sensing procedure indication to the UE, wherein the sensing procedure indication comprises a request to report sensing results for a sensing procedure associated with the security procedure, an indication of whether the UE is to detect the interfering wireless device, or a combination thereof.

Aspect 25: The method of aspect 24, further comprising: monitoring for one or more sensing reports based at least in part on the sensing procedure indication.

Aspect 26: The method of any of aspects 20 through 25, further comprising: selecting the UE from a set of wireless devices of the radar system based at least in part on a position of the UE, a radar direction of the UE, a transmit power associated with the UE, or any combination thereof.

Aspect 27: The method of any of aspects 20 through 26, wherein selecting the type of challenge, the timing information, or both for the security procedure comprises: randomly selecting the type of challenge, the timing information, or both for the security procedure.

Aspect 28: The method of any of aspects 20 through 27, wherein the timing information comprises a start time associated with the security procedure, a number of frames for the security procedure, an end time of the security procedure, one or more challenge intervals for the security procedure, a duration of the challenge interval, a periodicity for the security procedure, or any combination thereof.

Aspect 29: The method of any of aspects 20 through 28, wherein the type of challenge instructs the UE to remain silent for a duration of the challenge interval.

Aspect 30: The method of any of aspects 20 through 29, wherein the type of challenge instructs the UE to transmit radar signals according to a set of operating parameters for the security procedure for a duration of the challenge interval.

Aspect 31: An apparatus for wireless communications at a UE, comprising a processor; memory coupled with the processor; and one or more instructions stored in the memory and executable by the processor to cause the apparatus to perform a method of any of aspects 1 through 19.

Aspect 32: An apparatus for wireless communications at a UE, comprising at least one means for performing a method of any of aspects 1 through 19.

Aspect 33: A non-transitory computer-readable medium storing code for wireless communications at a UE, the code comprising instructions executable by a processor to perform a method of any of aspects 1 through 19.

Aspect 34: An apparatus for wireless communications at a wireless device, comprising a processor; memory coupled with the processor; and one or more instructions stored in the memory and executable by the processor to cause the apparatus to perform a method of any of aspects 20 through 30.

Aspect 35: An apparatus for wireless communications at a wireless device, comprising at least one means for performing a method of any of aspects 20 through 30.

Aspect 36: A non-transitory computer-readable medium storing code for wireless communications at a wireless device, the code comprising instructions executable by a processor to perform a method of any of aspects 20 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting, by the UE operating in a first detection mode, a first set of radar signals in accordance with a first set of operating parameters for radar signaling;
switching from the first detection mode to a second detection mode associated with a second set of coordinated operating parameters for radar signaling, the second set of coordinated operating parameters associated with the UE and one or more wireless devices in coordination with the UE; and
performing, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

2. The method of claim 1, wherein performing the security procedure comprises:
refraining from transmitting radar signals during the challenge interval; and
monitoring for one or more interfering radar signals from the interfering wireless device during the challenge interval.

3. The method of claim 1, wherein performing the security procedure comprises:
transmitting, during the challenge interval, a second set of radar signals in accordance with the second set of coordinated operating parameters.

4. The method of claim 1, further comprising:
receiving, from a wireless device, an indication of the security procedure for detecting the interfering wireless device, the indication of the security procedure indicating a type of challenge for the security procedure, timing information for the security procedure, or any combination thereof, wherein the timing information comprises a start time associated with the security procedure, a number of frames for the security procedure, an end time of the security procedure, one or more challenge intervals for the security procedure, a duration of the challenge interval, or any combination thereof.

5. The method of claim 4, wherein receiving the indication of the security procedure comprises:
receiving the indication of the security procedure via a groupcast message for a group of wireless devices including the UE and the one or more wireless devices or a unicast message for the UE.

6. The method of claim 4, wherein receiving the indication of the security procedure comprises:
receiving an encrypted message comprising the indication of the security procedure; and
decrypting the encrypted message based at least in part on an encryption key associated with the UE and the one or more wireless devices in coordination with the UE.

7. The method of claim 4, wherein the indication of the security procedure indicates the timing information for the security procedure, wherein performing the security procedure comprises:
performing the security procedure at the start time indicated by the timing information and during the number of frames indicated by the timing information.

8. The method of claim 7, wherein the security procedure comprises a default security procedure or a fallback security procedure.

9. The method of claim 4, wherein the indication of the security procedure indicates the type of challenge for the security procedure, wherein performing the security procedure comprises:
performing the security procedure according to a periodicity for the security procedure, wherein the second set of coordinated operating parameters comprises a waveform different from the first set of operating parameters.

10. The method of claim 4, wherein the timing information comprises random timing information indicating an aperiodicity associated with the security procedure.

11. The method of claim 4, wherein the indication of the security procedure indicates a sensing procedure for the security procedure, wherein performing the security procedure comprises:
monitoring a set of radar resources for one or more radar signals in accordance with the sensing procedure; and
transmitting a report indicating one or more measurement results of the sensing procedure based at least in part on the monitoring.

12. The method of claim 11, wherein the one or more measurement results comprises a hard indicator corresponding to whether the interfering wireless device is present or a soft indicator corresponding to whether the interfering wireless device is present, a field of view associated with the UE, a position of the UE, a direction associated with a radar component of the UE, or any combination thereof.

13. The method of claim 12, wherein the hard indicator comprises a Boolean value associated with whether the interfering wireless device is present based at least in part on the monitoring and the soft indicator comprises a probability associated with whether the interfering wireless device is present, a signal strength associated with the one or more radar signals based at least in part on the monitoring, or any combination thereof.

14. The method of claim 11, wherein the report is transmitted to a base station via an uplink message, a sidelink message, or both, to at least one wireless device of the one or more wireless devices via a sidelink message, to the one or more wireless devices via a groupcast message or a broadcast message, or any combination thereof.

15. The method of claim 1, further comprising:
transmitting a trigger message to at least one wireless device of the one or more wireless devices, wherein the trigger message instructs the at least one wireless device to perform a corresponding security procedure during the challenge interval.

16. The method of claim 15, wherein transmitting the trigger message comprises:
transmitting an encrypted message comprising the trigger message via a broadcast message to the one or more wireless devices, a groupcast message to a group of wireless devices including the at least one wireless device, a unicast message to the at least one wireless device, or any combination thereof.

17. The method of claim 15, wherein the corresponding security procedure comprises:
a request to apply a same security procedure as the UE during the challenge interval, to remain silent during the challenge interval, to perform a sensing procedure for the security procedure during the challenge interval, to report sensing results associated with the sensing procedure, or any combination thereof.

18. The method of claim 17, wherein the request comprises a request type, the request type comprising on of an optional request or a mandatory request.

19. The method of claim 17, wherein the corresponding security procedure comprises the request to report sensing results associated with the sensing procedure, the method further comprising:
receiving, from the at least one wireless device, a sensing report, a hard indicator, a soft indicator, or some combination thereof, indicating one or more sensing results of the sensing procedure at the at least one wireless device; and
transmitting a combined sensing report to a wireless device, the combined sensing report, the hard indicator, the soft indicator, or some combination thereof, including the one or more sensing results and at least one additional sensing result.

20. A method for wireless communications at a wireless device, comprising:
selecting a type of challenge, timing information, or both for a security procedure for detecting an interfering wireless device within a radar system;
transmitting, to a user equipment (UE), an indication of the security procedure for detecting the interfering wireless device, the indication of the security procedure indicating the type of challenge for the security procedure, the timing information for the security procedure, or both; and
monitoring a set of radar resources for one or more messages during a challenge interval associated with the security procedure based at least in part on the indication of the security procedure.

21. The method of claim 20, wherein transmitting the indication of the security procedure comprises:
transmitting a groupcast message to a group of wireless devices including the UE and one or more wireless devices in coordination with the UE, wherein the groupcast message comprises the indication of the security procedure.

22. The method of claim 20, wherein transmitting the indication of the security procedure comprises:
transmitting a unicast message for the UE, wherein the unicast message comprises the indication of the security procedure.

23. The method of claim 20, wherein transmitting the indication of the security procedure comprises:
transmitting an encrypted message comprising the indication of the security procedure, wherein the encrypted message is encrypted based at least in part on an encryption key associated with the UE and one or more wireless devices in coordination with the UE.

24. The method of claim 20, wherein transmitting the indication of the security procedure comprises:
transmitting a sensing procedure indication to the UE, wherein the sensing procedure indication comprises a request to report sensing results for a sensing procedure associated with the security procedure, an indication of whether the UE is to detect the interfering wireless device, or a combination thereof.

25. The method of claim 24, further comprising:
monitoring for one or more sensing reports based at least in part on the sensing procedure indication.

26. The method of claim 20, further comprising:
selecting the UE from a set of wireless devices of the radar system based at least in part on a position of the UE, a radar direction of the UE, a transmit power associated with the UE, or any combination thereof.

27. The method of claim 20, wherein selecting the type of challenge, the timing information, or both for the security procedure comprises:
randomly selecting the type of challenge, the timing information, or both for the security procedure.

28. The method of claim 20, wherein the type of challenge instructs the UE to transmit radar signals according to a set of operating parameters for the security procedure for a duration of the challenge interval.

29. An apparatus for wireless communications at a user equipment (UE), comprising:
a processor;
memory coupled with the processor; and
one or more instructions stored in the memory and executable by the processor to cause the apparatus to, based at least in part on the one or more instructions:
transmit, by the UE operating in a first detection mode, a first set of radar signals in accordance with a first set of operating parameters for radar signaling;
switch from the first detection mode to a second detection mode associated with a second set of coordinated operating parameters for radar signaling, the second set of coordinated operating parameters associated with the UE and one or more wireless devices in coordination with the UE; and
perform, by the UE operating in the second detection mode and in accordance with the second set of coordinated operating parameters, a security procedure during a challenge interval associated with the security procedure, the security procedure for detecting an interfering wireless device different from the one or more wireless devices in coordination with the UE.

30. An apparatus for wireless communications at a wireless device, comprising:
a processor;
memory coupled with the processor; and
one or more instructions stored in the memory and executable by the processor to cause the apparatus to, based at least in part on the one or more instructions:
select a type of challenge, timing information, or both for a security procedure for detecting an interfering wireless device within a radar system;
transmit, to a user equipment (UE), an indication of the security procedure for detecting the interfering wireless device, the indication of the security procedure indicating the type of challenge for the security procedure, the timing information for the security procedure, or both; and
monitor a set of radar resources for one or more messages during a challenge interval associated with the security procedure based at least in part on the indication of the security procedure.
